(19) United States
(12) Patent Application Publication
(10) Pub. No.: US 2026/0112879 A1
(43) Pub. Date: Apr. 23, 2026

(54) Smart Circuit Breaker Systems and Methods

(71) Applicant: Noble Carbon LLC, Dover, DE (US)

(72) Inventors: Andrew Crane, Holden, MA (US); Jared Lebos, Holden, MA (US)

(21) Appl. No.: 19/367,167

(22) Filed: Oct. 23, 2025

Related U.S. Application Data
(60) Provisional application No. 63/710,955, filed on Oct. 23, 2024.

(51) Int. Cl. H02H 3/16; H02H 1/00

(52) U.S. Cl. CPC H02H 3/16; H02H 1/0007; H02H 1/0092

(57) ABSTRACT

Embodiments disclose a smart circuit breaker. A smart circuit breaker may include a line side connection to a power distribution panel bus, a load side connection to at least one branch circuit, and an overcurrent protection mechanism. The smart circuit breaker further includes at least one relay coupled to the line side of the overcurrent protection mechanism, and a printed circuit board assembly. The printed circuit board assembly includes a processor and a memory with computer code instructions stored thereon configured to cause the processor control operation of the at least one relay, record electrical characteristics through the smart circuit breaker, and provide at least one network connection to the smart circuit breaker. The smart circuit breaker may be backwards compatible in that it can be incorporated installed in into an existing legacy circuit breaker distribution panel, such as the existing electrical distribution system.

### RELATED APPLICATION

This application claims the benefit of U.S. Provisional Application No. 63/710,955, filed on Oct. 23, 2024. The entire teachings of the above application are incorporated herein by reference.

### BACKGROUND

Smart home devices exist to control appliances and fixtures in a home through the use of devices connected to a network, such as the internet. The ability to control the electrical distribution within a home via a smart home device, however, is an area where this technology lags behind. Some advancements in this space involve the use of network connected electrical distribution panels.

### SUMMARY

While technologies exist to control electrical distribution using a smart home device, they typically involve a complete replacement of the existing panel to retrofit the device into an existing distribution system, such as a standard electrical panel. This can prove to be invasive and expensive, and these systems tend to be ill-suited for dwelling usage. Example embodiments of the present disclosure include solutions that can help alleviate challenges associated with electrical distribution using a smart home device. Example embodiments disclosed herein include compact retrofit systems that are designed to transform a legacy electrical distribution system into a smart home device.

An embodiment is directed toward a smart circuit breaker. Such a smart circuit breaker includes a line side connection to a power distribution panel bus, a load side connection to at least one branch circuit, and at least one relay (e.g., an electronically controlled switch) coupled to a line side of the at least one branch circuit. The smart circuit breaker further includes a printed circuit board assembly. The printed circuit board assembly includes a processor and a memory with computer code instructions stored thereon configured to cause the processor to perform at least one of: control operation of the at least one relay, record electrical characteristics through the smart circuit breaker, and provide at least one network connection to the smart circuit breaker.

An embodiment further includes at least one sensing coil operatively coupled to the at least one relay and the printed circuit board assembly, the at least one sensing coil configured to provide a measurement of current flow to the branch circuit to the printed circuit board assembly.

An embodiment further includes at least one resistive shunt operatively coupled to the at least one relay and to the printed circuit board assembly, the at least one resistive shunt configured to provide a measurement of at least one of current and voltage to the branch circuit to the printed circuit board assembly.

According to an embodiment, the processor and the memory with computer code instructions stored thereon are further configured to cause printed circuit board assembly to at least one of: (i) record at least a measurement and a waveform of at least one of current and voltage, (ii) indicate the current status of the smart circuit breaker via at least one light emitting diode (LED), (iii) enable communication between at least one additional smart circuit breaker via the at least one network connection, (iv) identify a ground fault within the branch circuit, and produce an open circuit in response to the identifying of an ground fault; and (v) identify an arc fault within the branch circuit, and produce an open circuit in response to the identifying of an arc fault, or any combination thereof. In such an embodiment, the smart circuit breaker may be configured to produce an open circuit responsive to a value of the measured waveform.

According to an embodiment, the at least one relay may be an electro-mechanical switch configured to respectively open and close a circuit.

In a further embodiment, the printed circuit board assembly may be configured to cause the at least one relay to respectively open and close the at least one branch circuit responsive to a condition. In such an embodiment, the condition may be any one of: (i) a fault scenario, (ii) a wireless communication, (iii) a wired communication, and (iv) a schedule or timer.

Another embodiment further includes an overcurrent protection mechanism coupled to the smart circuit breaker. In such an embodiment, the overcurrent protection mechanism may be at least one of: (i) a thermal based (e.g., a fuse, or a similar component heating to a failure point such as, for example, a bi-metallic strip), (ii) a magnetically based, (iii) a digitally based, and (iv) a temperature based (e.g., electronically opening in response to a particular temperature having been measured) overcurrent protection mechanism, or any combination thereof.

According to an embodiment, the at least one relay may be a double latching relay.

Another embodiment further includes a firmware integrated to the printed circuit board assembly. In such an embodiment, the integrated firmware may be configured to cause the processor and memory with computer code instructions stored thereon to at least one of: (i) manage the at least one network connection, (ii) operatively couple the printed circuit board assembly to the overcurrent protection device, (iii) interface between an internet of things (IoT) cloud server and the smart circuit breaker, (iv) interface between the smart circuit breaker and at least one additional smart circuit breaker, (v) maintain a secure socket layer communication, manage over the air updates, sense errors in the system, and (vi) manage integrated firmware patches. Moreover, in such an embodiment, integrated firmware may be further configured to update at least one parameter configured to cause the at least one relay to produce an open circuit.

In an embodiment, the processor and the memory and the computer code instructions stored thereon may be further configured to record and store data associated with at least one branch circuit.

According to an embodiment, data may be at least one of: (i) power usage monitored by the circuit breaker, (ii) a current waveform (i) a voltage waveform, (iv) an indication of active circuits, (v) energy usage history, (vi) predictions on future energy needs or habits, (vii) a timer, (viii) a schedule, (ix) an indication of smart circuit breaker status, (x) a fault detection, (xi) fault detection history, (xii) an indication of temperature, and (xiii) power outages, or any combination thereof.

In still a further embodiment, the memory may further include an integrated software configured to: provide a graphic user interface (GUI) on an IoT connected user device, represent data via the GUI to the IoT connected user device, communicate with a cloud server, and facilitate user log in authentication. In such an embodiment, the integrated software and the GUI may be configured to at least one of: (i) receive data, (ii) control a timer, (iii) control a schedule, (iv) view data, (v) transmit data, (vi) control a status of the smart circuit breaker, (vii) latch and unlatch the at least one relay, (viii) perform an update, (ix) control a plurality of smart circuit breakers, or any combination thereof.

According to an embodiment, the integrated software may be any one of an iOS, Android, or hypertext markup language (HTML) based software application.

In a further embodiment, the integrated software may be further configured to track at least a voltage drop or a current draw across an appliance (e.g., a hot water heater), and control a branch circuit associated with the appliance.

In yet a further embodiment, the integrated software further may further include a lossless audio codec configured to compress data prior to communicating with the cloud server.

According to an embodiment, the user device may include an integrated global position system, the user device further configured to calibrate a clock controller (e.g., a real time clock) of the printed circuit board assembly.

In another embodiment, the integrated software may be further configured to monitor at least one line phase for a change.

In yet another embodiment, the integrated software may further include an artificial intelligence component. In such an embodiment, the artificial intelligence component may be a neural network based or a large language model based artificial intelligence. Moreover, in an embodiment, the artificial intelligence component may be trained on at least one dataset to recognize a fault scenario. To continue, in such an embodiment, the artificial intelligence component may be configured to at least one of: (i) collect data, (ii) build language models from the data collected, (iii) monitor the condition of the smart circuit breaker, (iv) monitor the status of the smart circuit breaker, (v) identify a fault in a branch circuit, (vi) identify a location of the fault identified, (vii) determine a type of fault identified, (viii) communicate with a cloud server, (ix) communicate with a weather service, (x) analyze electrical characteristics of a branch circuit, (xi) communicate with an internet of things connected device, (xii) communicate with integrated software to open or close a circuit, (xiii) communicate with a wireless network, and (xiv) identify at least one appliance connected to a branch circuit, or any combination thereof.

According to an embodiment, the at least one network connection may be any one of: (i) an internet connection, (ii) an intranet connection, (iii) a Bluetooth connection, (iv) a Wi-Fi connection, (v) a wireless access network connection, (vi) a local area network connection, (vii) a cloud server, and (viii) a cellular connection, or any combination thereof.

In an embodiment, the smart circuit breaker may be configured to be either a two-pole breaker or a tandem breaker during an instillation of the smart circuit breaker.

In an embodiment, the smart circuit breaker may be configured to enable or disable ground fault circuit interrupting (GFCI), and to enable or disable arc fault circuit interrupting (AFCI). Such an embodiment may further include a fuse, and wherein the fuse is connected AFCI or GFCI is enabled, and wherein the fuse is disconnected AFCI or GFCI is disabled.

According to another embodiment, the at least one relay may be a mechanical switch configured to mechanically toggle the at least one relay in the open and the closed positions, respectively. Such an embodiment further includes, a spring detent on the mechanical switch, the spring detent configured to disengage the mechanical switch from the at least one relay when the mechanical switch toggles the at least one relay in the closed position.

An embodiment further includes a temperature sensor configured to provide a measurement of temperature to the printed circuit board assembly.

According to an embodiment, the printed circuit board assembly may be further configured to monitor current on the at least one mains.

An embodiment may further include an integrated battery backup. In such an embodiment, the integrated battery backup may be any one of a cell battery or a super-capacitor.

An embodiment may further include at least one sensing coil operatively coupled to the at least one relay and the printed circuit board assembly, and at least one resistive shunt operatively coupled to the at least one relay and to the printed circuit board assembly. In such an embodiment, the at least one sensing coil may be configured to provide a measurement of current flow to the branch circuit to the printed circuit board assembly; and the at least one resistive shunt configured to provide a measurement of at least one of current and voltage to the branch circuit to the printed circuit board assembly.

Another embodiment is directed toward a method of providing overcurrent protection via a smart circuit breaker. Such a method may include connecting a line side connection to a power distribution panel bus, a load side connection to at least one branch circuit, and an overcurrent protection mechanism, connecting at least one relay coupled to the line side of the overcurrent protection mechanism, and connecting a printed circuit board assembly. In such an embodiment, the printed circuit board assembly including a processor and a memory with computer code instructions stored thereon may be configured to cause the processor to: perform at least one of: controlling operation of the at least one relay, recording electrical characteristics through the smart circuit breaker, and providing at least one network connection to the smart circuit breaker. This method may be configured to implement any embodiments, or combination of embodiments, described herein.

Another embodiment is directed toward a method of controlling electrical load distribution. Such a method may include configuring a smart circuit breaker to be the main overcurrent protection device for an electrical distribution panel, identifying, via the smart circuit breaker, a plurality of electrical loads on a load side of the smart circuit breaker within the electrical distribution panel. The method may continue by balancing the plurality electrical loads between a plurality of electrical phases within the electrical distribution panel. This computer readable medium may be configured to implement any embodiments, or combination of embodiments, described herein.

According to an embodiment, balancing the plurality of electrical loads further includes at least one of: controlling power distribution to each electrical phase of the plurality of electrical phases, and communicating a load balancing suggestion to a user.

An embodiment may further include an artificial intelligence component. Such an embodiment may further include the artificial intelligence component (i) learning the load balancing properties of the electrical distribution panel, (ii) instructing the smart circuit breaker on how to balance the loads, and (iii) communicating a load balancing suggestion to a user.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a 3D model of a smart circuit breaker, according to an embodiment.

FIG. 2 is an exploded view of the 3D model of the smart circuit breaker of FIG. 1, according to an embodiment.

FIG. 3 is a flow diagram of a method of providing overcurrent protection via a smart circuit breaker, according to an embodiment.

FIG. 4 is a line diagram of an internal structure of a smart circuit breaker, according to an embodiment.

FIG. 5 is a line diagram of an internal structure of a control module of a smart circuit breaker, according to an embodiment.

FIG. 6 is a circuit diagram of an energy metering integrated circuit (IC) and its supporting components utilized in a smart circuit breaker, according to an embodiment.

FIG. 7 is a circuit diagram of an isolated direct current (DC) to DC power supply circuit utilized in a smart circuit breaker, according to an embodiment.

FIG. 8 is a circuit diagram of a buck-stepdown DC to DC power supply circuit, utilized in a smart circuit breaker, according to an embodiment.

FIG. 9 is a circuit diagram of a voltage regulator circuit utilized in a smart circuit breaker, according to an embodiment.

FIG. 10 is circuit diagram of a semiconductor-based relay driver utilized in a smart circuit breaker, according to an embodiment.

FIG. 11 is a circuit diagram of a high-voltage buck converter utilized in a smart circuit breaker, according to an embodiment.

FIG. 12 is a circuit diagram of a microcontroller and an isolated communications bus utilized in a smart circuit breaker, according to an embodiment.

FIG. 13 is a circuit diagram of a ground-fault-interrupter (GFI) sensing circuit implementing a current transformer utilized in a smart circuit breaker, according to an embodiment.

FIG. 14 shows circuit diagrams of a GFI sensing circuit implementing a resistive shunt utilized in a smart circuit breaker, according to an embodiment.

FIG. 15 is a circuit diagram of a microcontroller for an integrated universal-serial-bus (USB), and a network connection, according to an embodiment.

FIG. 16 is a simplified block diagram of an example implementation of a network in communication with an embodiment.

FIG. 17 is a simplified block diagram of any internal structure of a computer/computing node in a processing environment of an embodiment.

### DETAILED DESCRIPTION

A description of example embodiments follows.

Existing methods for upgrading an existing electrical distribution system to an internet connected smart electrical distribution system involve a complete overhaul of the existing panel, and in many cases involves replacing the existing panel with a new panel. These methods are invasive and expensive, and as such, a more affordable and user-friendly solution is required. Embodiments provide a smart circuit breaker that may enable easy upgrading of existing electrical distribution systems by retrofitting into existing circuit breaker slots in an existing electrical distribution panel. Embodiments provide for user control and monitoring multiple branch circuits from an Internet of Things (IoT) connected device, such as, for example, a desktop computer or a cellular phone.

According to an embodiment, the smart circuit breaker device may include a tandem (i.e., two side by side), a single pole breaker, or a two-pole breaker, and may be configurable as to a breaker type upon installation. Such a breaker may be a backwards compatible circuit breaker. Backwards compatible as used herein may refer to the ability of the circuit breaker device to be installed in an existing legacy circuit breaker distribution panel, and therefore the existing electrical distribution system. The smart circuit breaker device may include at least one traditional circuit breaker overcurrent protection device, such as, for example, at least one fuse, a magnetically operated switch, a temperature operated switch, a thermos-magnetic switch, a shunt, a current operated switch, a voltage operated switch, or other suitable means of providing overcurrent protection to a branch circuit.

Further, the smart circuit breaker device may include at least one printed circuit board assembly (PCBA). According to an embodiment, the PCBA may include a processor, and a memory with computer code instruction stored thereon. The processor, and the memory with the computer code instruction stored thereon may be configured to control, communicate, or otherwise interface with a plurality of components associated with the smart circuit breaker device. For example, the smart circuit breaker device may include one or more sensing coils configured to measure electrical characteristics (such as current or voltage) distributed to at least one branch circuit located downstream from the overcurrent protection device. The smart circuit breaker device may also include one or more relays, for example, a double latching relay. In response to communication from the processor, the double latching relay may be configured to open, and therefore disconnect power to a branch circuit, or close, and therefore connect power to a branch circuit. According to an embodiment, the PCBA may include a network connection to internet, via, for example Wi-Fi or Bluetooth.

Moreover, the smart circuit breaker is designed to use for example, Wi-Fi, cellular, satellite, or ethernet for internet connectivity, in addition to the ability to operate locally without internet to communicate with a user's device (e.g., mobile device) for commands. The controller may also incorporate interoperability with local devices (EV chargers, batteries, etc.) via Modbus, CAN bus, local API calls, and WAN API calls.

Embodiments therefore provide for additional control and monitoring of an electrical distribution system. Via an application on a user device, such as a mobile device or a desktop computer, a user may be able to both monitor and control an electrical distribution system. The smart circuit breakers may send and receive information to the user device, providing real time updates to a user. These updates may provide a user with an indication of power consumption, load distribution, as well as fault and a location of said fault within the system. These smart circuit breakers also provide a user greater control over a distribution system by enabling a user to remotely toggle branch circuits by controlling relays within the smart circuit breakers. This may allow a user to remotely close or open a branch circuit by communicating with the smart circuit breaker over an internet connection.

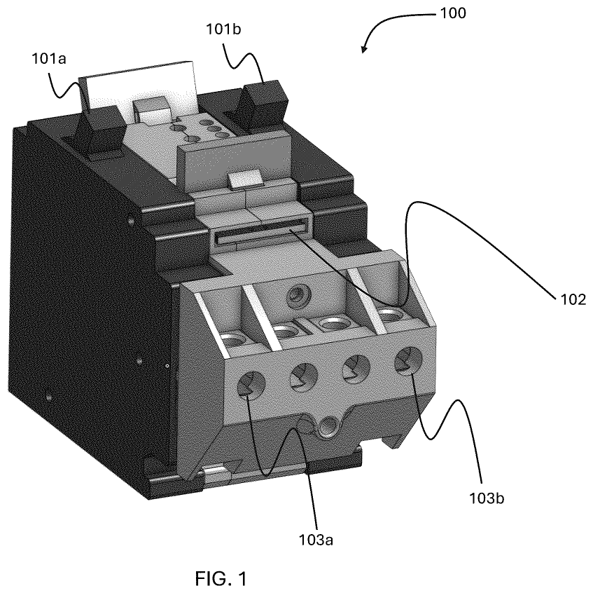

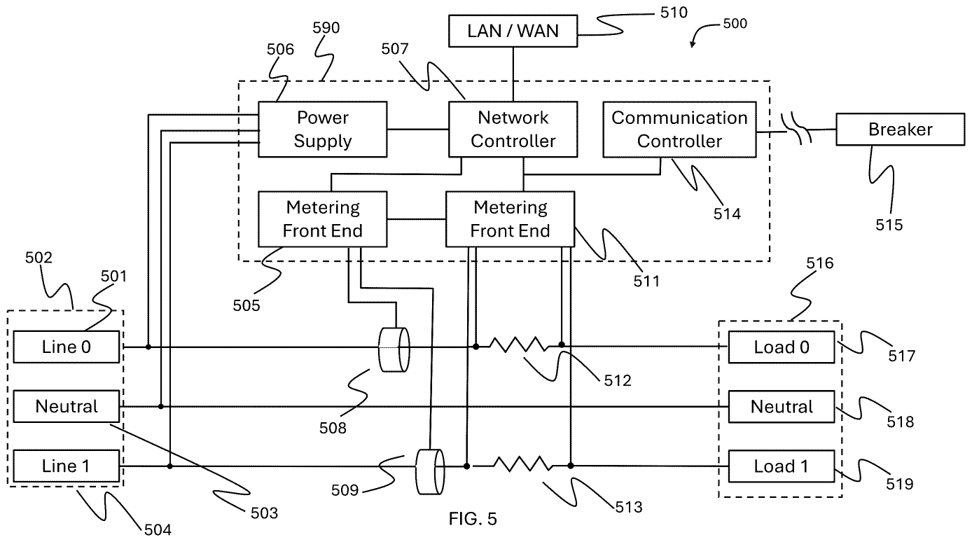

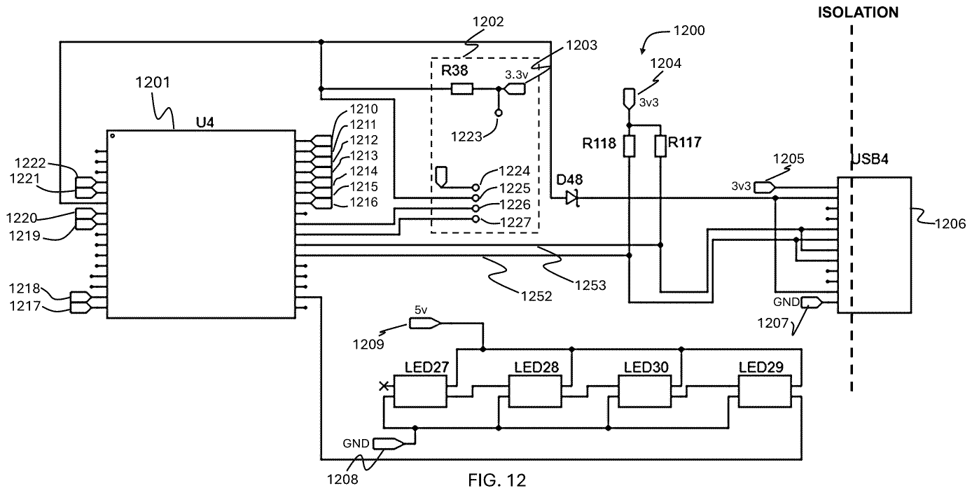

FIG. 1 is a three-dimensional (3D) model of a smart circuit breaker 100, according to an embodiment. The smart circuit breaker 100 may include overcurrent protection devices 101a and 101b. While only two overcurrent protection devices 101a and 101b are shown, it should be understood that the smart circuit breaker may include a plurality of overcurrent protection devices and the plurality of overcurrent protection devices may be single-pole, double-pole, latching, tandem, arc fault circuit interrupting (AFCI), ground fault circuit interrupting (GFCI), or similar. The smart circuit breaker 100 may include a PCBA 102 configured to operatively control the smart circuit breaker device. The PCBA 102 may be configured to control the operations of the smart circuit breaker 100. For example, the PCBA 102 may be configured to communicate with the communication controller (See, FIG. 5) and the network controller (See, FIG. 5). The smart circuit breaker 100 may include a plurality of light-emitting-diodes (LEDs) (See, FIG. 12) controlled by the PCBA 102, configured to present status information of both the smart circuit breaker 100 as well as any downstream branch circuits to an operator. The smart circuit breaker 100 is configured to be installed in legacy circuit boards and may include screw down terminals 103a and 103b for load side connection to branch circuits. As such, the relative geometry and dimensions of the smart circuit breaker 100 are such that the device 100 is capable of connecting to a standard electrical panel circuit bus, bar, slot, or similar electrical and physical connection points.

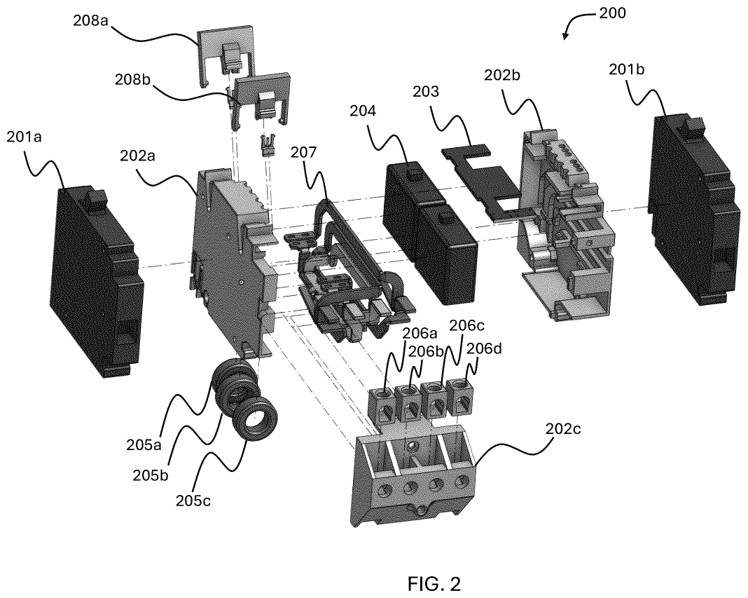

FIG. 2 is an exploded view of a 3D model of a smart circuit breaker 200, according to an embodiment. Smart circuit breaker 200 may include two one-half inch circuit breaker overcurrent protection devices 201a and 201b. Overcurrent protection devices 201a and 201b may be available in a range of voltage and current configurations and may include GFCI protection as well as AFCI protection. Outer shells 202a and 202b encapsulate the inner mechanisms of the smart circuit breaker device, for example, shells 202a-b encapsulate busses 207, sensing coils 205a-c, switches 204, the PCBA 203 and the detents 208a-b. According to an embodiment, circuit board assembly 203 may be a printed circuit board assembly. Circuit board assembly 203, according to an embodiment, may have a processor and a memory with computer code instructions stored thereon. The circuit board assembly 203, with the processor and memory with computer code instructions may be configured to, by way of non-limiting examples, make and record measurements of voltage, current, and their respective waveforms, latch and unlatch onboard relays 204, signal the state of the device using onboard LEDs (not shown), react to ground faults, arc faults, over current faults, or any combination thereof. Further, the circuit board assembly 203 may communicate with other breaker boards (e.g., other smart circuit breaker devices) as well as a control board. Integrated relays 204, or other similar electro-mechanical switches, may be configured to open and close in response to a command from the circuit board assembly, said opening and closing of the integrated relays configured to open and close, respectively, one or more circuits coupled to the load side the circuit of the overcurrent protection device 200.

Still referring to FIG. 2, smart circuit breaker 200 may also include a plurality of sensing coils 205a-c. According to an embodiment, sensing coils 205a-c may each be operably coupled to the switch 204, and may be further configured to provide a measurement of current flow to the PCBA 203, where the PCBA 203 may be configured to record the current flow to at least one branch circuit. Further, according to an embodiment, the sensing coils 205a-c may also be configured to sense for ground faults in at least one branch circuit and provide the PCBA 203 with an indication of a ground fault in at least one branch circuit. The smart circuit breaker 200 further includes screw-down terminals 206a and 206d that may be used to provide line voltage to the branch circuit. In an embodiment where the smart circuit breaker 200 is configured to identify at least one of a ground fault or an arc fault within a branch circuit, additional screw-down terminals 206b and 206c may be used to provide neutral returns for the branch circuit. The overcurrent device 200 may include buses 207 for routing power through the overcurrent protection device 200 such that power may, for example, be accurately metered and fed through the necessary sensors for ground fault interrupt and arc fault interrupt. The overcurrent device 200 may include spring detents 208a and 208b, such that the relays 204 or similar electro-mechanical switches may be able to be manually toggled “on” and “off” while still ensuring that the breakers 201a or 201b cannot be held in the “on” position during a fault scenario.

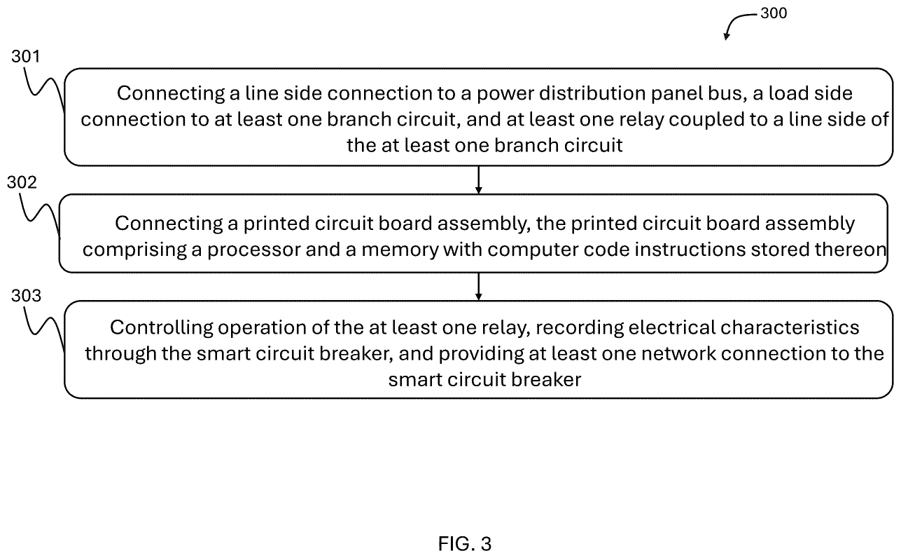

FIG. 3 is a flow diagram of a method 300 of providing overcurrent protection via a smart circuit breaker, according to an embodiment. The method 300 begins at step 301 by connecting a line side connection of the smart circuit breaker to a power distribution panel bus, connecting a load side connection of the smart circuit breaker to at least one branch circuit, and connecting at least one relay coupled to a line side connection of the at least one branch circuit. According to an embodiment of the method 300, the smart circuit breaker may additionally contain an overcurrent protection device or mechanism. Further, the overcurrent protection mechanism may be any one of a: (i) thermal based, (ii) magnetically based, (iii) digitally based, or (iv) temperature based overcurrent protection mechanism, or any combination thereof. According to an embodiment, the at least one relay may be a double latching relay, an electromechanical switch configured to respectively open and close a circuit on the line side of an overcurrent protection device, or any other suitable relay. Thereafter, the method 300 at step 302 connects a printed circuit board assembly (PCBA). The PCBA may include a processor, and a memory with computer code instructions stored thereon. The method 300 continues at step 303 by controlling operation of the at least one relay, recording electrical characteristics through the smart circuit breaker, and providing at least one network connection to the smart circuit breaker. Since the at least one relay is connected to the line side of the overcurrent protection device, controlling the at least one relay effectively toggles power to the branch circuit connected to a respective circuit breaker.

According to an embodiment, the at least one wireless network connection of the smart circuit breaker of the method 300 may be any one of (i) an internet connection, (ii) an intranet connection, (iii) a Bluetooth connection, (iv) a Wi-Fi connection, (v) a wireless access network connection, (vi) a local area network connection, (vii) a cloud server, (viii) a cellular network, or any combination thereof.

According to another embodiment of the smart circuit breaker of method 300, the relay may include a mechanical switch configured to mechanically toggle the relay in the open and the closed positions, respectively. Such an embodiment may also include a spring detent on the mechanical switch configured to disengage the mechanical switch from the at least one relay when the mechanical switch toggles the at least one relay in the closed position. For example, to allow for the breaker to be operated even in a scenario where it has lost communication, the smart circuit breaker may include a physical mechanism that allows for the manual toggling of the relay. To comply with safety regulations, the mechanism allows the user to toggle the relay on or off but does not allow the user to hold the relay in the “on” state during a fault scenario. The mechanism may include a spring detent so that it can be slid back over the mechanical switch on the relay in the case where the relay was turned “off” electrically. When the mechanism is used to turn “on” the relay mechanically, it disengages with the relay as it reaches the “on” position, allowing the relay to be switched “off” electronically even if the mechanism is held in the “on” position.

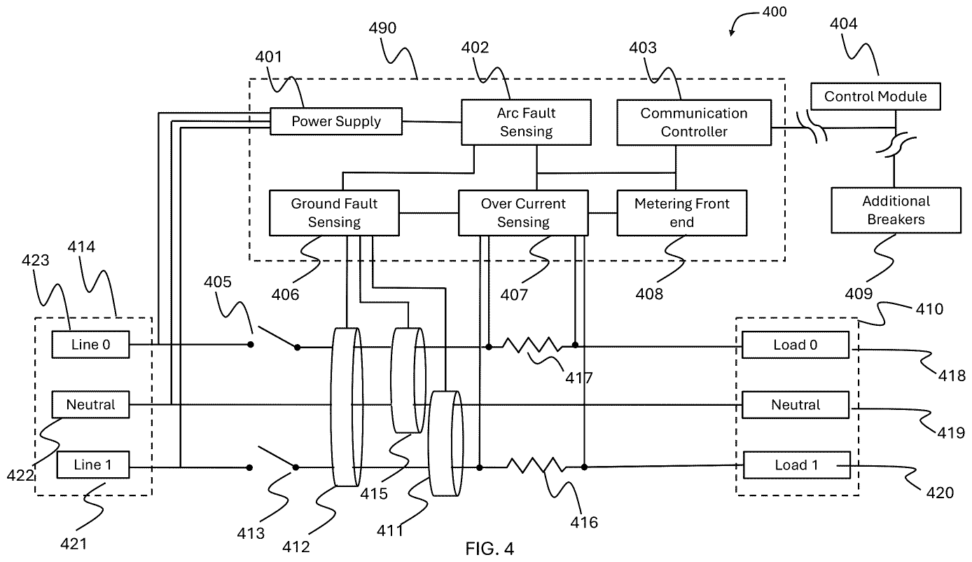

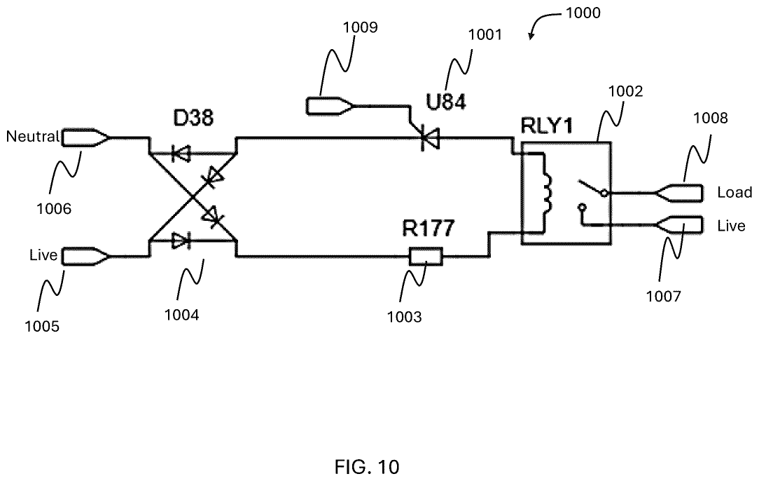

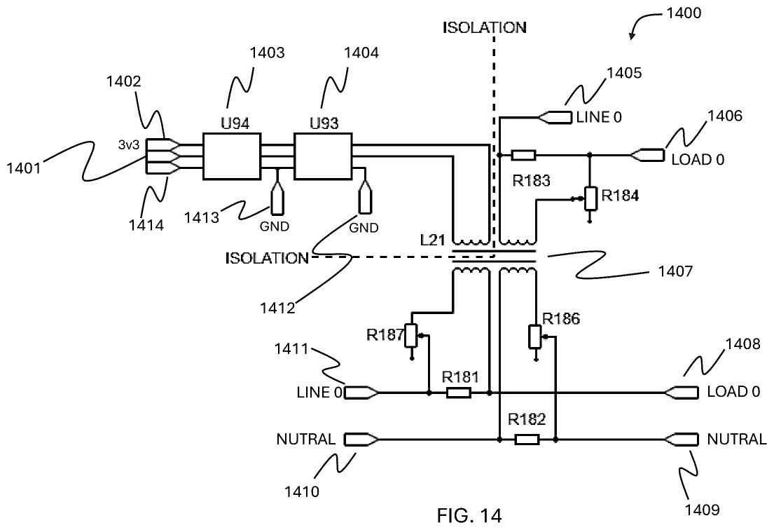

The smart circuit breaker of method 300 may also include at least one at least one sensing coil (See, FIG. 2 205a-c) operatively coupled to the at least one relay (See, FIG. 2 204, FIG. 4 405 and 413, and FIG. 10 1000) and the printed circuit board assembly. In such an embodiment, the at least one sensing coil may be configured to provide a measurement of current flowing to the branch circuit to the printed circuit board assembly. In addition, the smart circuit breaker of method 300 may include at least one resistive shunt (See, FIG. 4 416-417, FIG. 5 512-513, and FIG. 14 1400) operatively coupled to the at least one relay and to the printed circuit board assembly. In such an embodiment, the at least one resistive shunt may be to provide a measurement of both current and voltage to the branch circuit to the printed circuit board assembly.

For example, the resistive shunts may be utilized to sense a difference in current between line and neutral. An embodiment may include, for example, at least two shunts (one on each live and one on neutral). The shunts may be calibrated to within a few nanohms of each other and may then become a mated set. Such matched sets may be assembled into a circuit whereby the shunts act as the AC voltage sources on galvanically isolated coils on a transformer. These signals may be passed through active and/or passive filtering and/or amplification to ensure proper operation in a range of 0-60 amps at 120-240 volts. Such an embodiment may also include additional components such as laser trimmed resistors for the purposes of calibration.

Moreover, low resistive shunts paired with calibrated trimming of the signals may be utilized to ensure they are balanced for matching currents, rather than the traditional method of a toroidal sensing coil for sensing a current imbalance. The signals may be post-processed through operative amplifiers and then compared or added together either through the use of ADC conversion and then computationally summed or summed through the use of an inverting summing amplifier. This approach allows for the use of four shunts to monitor for three distinct GFI scenarios, i.e., a two-pole fault, and either of the individual single-pole faults.

According to an embodiment, the smart circuit breaker of method 300, with the processor and the memory with computer code instructions stored thereon may also: (i) record both a measurement and a waveform for current and voltage through the smart circuit breaker and/or the branch circuit, (ii) indicate the current status of the smart circuit breaker via at least one light emitting diode (LED) (See, FIG. 12 LED 27-30) visible from the external shell of the smart circuit breaker, (iii) enable communication between at least one additional smart circuit breaker via the at least one network connection (See, FIG. 5 507, 510, 514, 515), (iv) identify a ground fault within a branch circuit, and produce an open circuit (e.g., open, or provide a signal to open, the at least one relay) in response to identifying a ground fault, and (v) identify an arc fault within the branch circuit, and produce an open circuit in response to the identifying of an arc fault, or any combination thereof. In embodiments, the smart circuit breaker may be configured to produce an open circuit (e.g., open the relay) in response to a condition. Such a condition may be a value of a measured waveform, a time current curve, a fault scenario, a wireless communication, a schedule, or a timer, for a few non limiting examples.

For example, due to the accuracy and frequency at which voltage and current waveforms are sampled, it is possible for waveform data to inform the processor to trigger a fault. This is accomplished through real-time computing and an analog-to-digital converter (ADC) front end looking for trends or data points over a given threshold, or other algorithms. By reacting to this data for overcurrent faults instead of relying on magnetics, it is possible to programmatically select a trip curve (e.g., Type B, Type C, or Type D) at the time of commissioning the breaker, and thereafter via a firmware update. This avoids the reliance on changing between different physical traditional breakers to change the trip curve on a circuit.

In an embodiment of the smart circuit breaker of the method 300, the smart circuit breaker may also include an integrated firmware for the PCBA. The integrated firmware may be configured to perform a variety of tasks and interfaces. For a few non-limiting examples, the integrated firmware may: (i) manage at least one network connection, (ii) operatively couple the printed circuit board assembly to the overcurrent protection device, (iii) interface between an internet of things (IOT) cloud server and the smart circuit breaker, (iv) interface between the smart circuit breaker and at least one additional smart circuit breaker, (v) maintain a secure socket layer communication, manage over the air updates, sense errors in the system, and (vi) manage integrated firmware patches.

Moreover, in such an embodiment, the integrated firmware may be updated via connection to an internet or an intranet. Such an update to the firmware may push updates throughout the smart circuit breaker device. For example, a firmware update may update at least one parameter configured to cause the at least one relay to produce an open circuit. Such a parameter may be, for example, a time current curve, or a value of a measurement or waveform for current or voltage previously configured to cause the smart circuit breaker to produce an open circuit.

For example, The AFCI and GFCI systems may be able to be updated over the air, or via a wired connection to a programming device, regardless of whether they are using ML algorithms by updating their respective firmware.

Still referring to FIG. 3, in an embodiment of the smart circuit breaker of the method 300, the processor and the memory with computer code instructions stored thereon may be further configured to record and store data associated with at least one branch circuit. Data, as it may be referred to herein, may include but is not limited to (i) power usage monitored by the circuit breaker, (ii) a current waveform (i) a voltage waveform, (iv) an indication of active circuits, (v) energy usage history, (vi) predictions on future energy needs or habits, (vii) a timer, (viii) a schedule, (ix) an indication of smart circuit breaker status, (x) a fault detection, (xi) fault detection history, (xii) an indication of temperature, and (xiii) power outages, or any combination thereof.

In an embodiment of the smart circuit breaker of the method 300, the PCBA with its processor and memory may further include an integrated software. The software may be, for example, an iOS, Android, or hypertext markup language (HTML) based software application. According to an embodiment, such a software may be configured to provide a graphic user interface (GUI) on an IoT connected user device (e.g., a mobile device, tablet, laptop, desktop computer, or similar), represent data via the GUI to the IoT connected user device, communicate with a cloud server, and facilitate user log in authentication. According to an embodiment, the integrated software and the GUI may be further configured to: (i) receive data, (ii) control a timer, (iii) control a schedule, (iv) view data, (v) transmit data, (vi) control a status of the smart circuit breaker, (vii) latch and unlatch the at least one relay, (viii) perform an update, (ix) control a plurality of smart circuit breakers, or any combination thereof.

To continue, the integrated software may also be configured to track at least a voltage drop or a current draw across an appliance, such as a hot water heater, control a branch circuit associated with the appliance, and monitor the health or condition of such an appliance. For example, since electric hot water heaters use a resistive heating element, the smart circuit breaker may track the voltage drop and/or current draw of a hot water heater against its toggling on and off. This allows the system to learn how the set points of the hot water heater relate to the switching of its thermostat. This information can be processed through machine learning or an algorithm to compute a regression against the data. This can be used to infer the temperature of the hot water heater based on its voltage drop or current draw. The inference may be improved through the input of a measured water temperature at the time of shut-off or any time it is on, so long as an accurate time can be corroborated between the temperature reading and the readings on the breakers.

The integrated software of the PCBA may also be configured to monitor at least one current on a mains. For example, a controller may monitor the current on the mains coming into a panel, and the smart circuit breaker may monitor and control the branch circuits they are connected to. This combination allows the system to guarantee that the panel will not exceed its rated limit, so long as that limit is correctly set on the controller during installation and the circuits under management make up more than the entire load installed above the rated limit of the panel. By adding additional breakers, the system becomes more capable of shedding lower-impact circuits if load shedding is required.

In addition, according to an embodiment, the integrated software may also include a lossless audio codec configured to compress data prior to communicating with the cloud server. For example, to transmit high-quality and high-resolution voltage and current waveform data, lossless audio codecs have been adapted to efficiently compress the data. This enables the data to be compressed on the controller of the PCBA of the smart circuit breaker and streamed to the cloud in real time.

The software may also be configured to monitor an incoming line phase to the distribution panel, and detect a change associated with the line phase. For example, through the use of a commissioning app and the global positioning system (GPS) capabilities of a user device running the software application app, the clock on the controller may be calibrated to well within 100 microseconds. This accuracy is maintained over time, either through the use of Temperature Compensated Crystal Oscillators (TCXOs) and regular check-ins with a user's device, or through the use of GPS in the controller itself. This allows for the monitoring of phase changes propagating through the grid. This information may be valuable to utilities as it may help identify problem areas, locations of poor quality electrical demand or supply, and likely locations of failing or aging electrical infrastructure. Phase data is already gathered from the smart circuit breakers to compare to each other and determine which circuits are on which phase of a panel. With this level of time-keeping accuracy, comparisons may be made not just across states and regions, but even across neighborhoods.

Still referring to FIG. 3, in an embodiment of the smart circuit breaker of the method 300, the smart circuit breaker also includes an artificial intelligence (AI) component, for example, a neural network based AI or large language model based AI. In such an embodiment, the AI component may be trained on at least one dataset to recognize a fault scenario, e.g., a ground fault, an arc fault, a line to line fault, a line to neutral fault, a line to ground fault, or similar. Moreover, such an AI component may further be configured to, according to an embodiment, (i) collect data, (ii) build language models from the data collected, (iii) monitor the condition of the smart circuit breaker, (iv) monitor the status of the smart circuit breaker, (v) identify a fault in a branch circuit, (vi) identify a location of the fault identified, (vii) determine a type of fault identified, (viii) communicate with a cloud server, (ix) communicate with a weather service, (x) analyze electrical characteristics of a branch circuit, (xi) communicate with an internet of things connected device, (xii) communicate with integrated software to open or close a circuit, (xiii) communicate with a wireless network, and (xiv) identify at least one appliance connected to a branch circuit, or any combination thereof.

Such an AI component may also be configured to (i) learn the load balancing properties of the electrical distribution panel, (ii) instruct the smart circuit breaker on how to balance the loads, and (iii) communicate a load balancing suggestion to a user.

According to an embodiment of the smart circuit breaker of method 300, the smart circuit breaker may be configured to enable or disable ground fault circuit interrupting (GFCI), and to enable or disable arc fault circuit interrupting (AFCI). This may be performed by a fuse, such a fuse when connected AFCI or GFCI is enabled, and when the fuse is disconnected AFCI or GFCI is disabled. For example, at the time of installation by a licensed installer, the installer may select whether a given breaker is two pole or tandem, has GFCI enabled or disabled (for both sides if two pole, for each side individually if tandem), and has AFCI enabled or disabled (for both sides if two pole, for each side individually if tandem). Once these choices are made and locked in, appropriate fuses may be blown on the PCBA to permanently lock in the selection. Since each system is operated separately, the fuses may be used to either stop a given system from receiving power, provide a given system with power, or as an input to the system to allow the fault signal of a given system to trigger a fault on the breaker.

In an embodiment of the smart circuit breaker of method 300, the smart circuit breaker may also include a temperature sensor configured to provide a measurement of temperature to the printed circuit board assembly. For example, the data from the temperature sensor, or sensors, may be used, through machine learning or other algorithms, to infer the temperature of the traditional circuit breakers on either side of the device. This may be used to, for example, warn users of impending fault scenarios, trip the relays in the breaker in advance of the traditional circuit breakers to allow them to cool down, and allow for the breaker to be reset electronically.

According to an embodiment of the smart circuit breaker of the method 300, the smart circuit breaker may also include an integrated battery backup. For example, to maintain connectivity, memory storage, timing, and some basic functionality when there is no power to the panel, the smart circuit breakers may be equipped with a backup power source in the form of either a coin cell battery or a super-capacitor.

Another embodiment of a smart circuit breaker may be configured to control electrical load distribution. For example, a smart circuit breaker, such as the smart circuit breaker of the method 300, may be configured to be the main overcurrent protection device for an electrical distribution panel. Such a smart circuit breaker may be configured to identify a plurality of electrical loads on a load side of the smart circuit breaker within the electrical distribution panel and balance the electrical loads on their respective phases. According to an embodiment, balancing the plurality of electrical loads may include controlling power distribution to each phase, or communicating a load balancing suggestion to a user. Moreover, such an embodiment may include an AI component, configured to learn the load balancing properties of the electrical distribution panel, instruct the smart circuit breaker on how to balance the loads, and communicating a load balancing suggestion to a user.

In an additional embodiment, a distribution panel may include pre-certified traditional circuit breakers installed in line with the smart circuit breaker of the method 300. By doing so, this may avoid the need for each smart circuit breaker to be certified for each individual panel. In such an embodiment, the panel should maintain its original certification, as the certified circuit breaker may act as a fail safe overcurrent protection.

Embodiments are designed for a high level of reliability, such that each subsystem may continue to operate and individually trip a relay even if it loses all communication with other systems in the breaker. The ability for the PCBA to continue monitoring for faults independent of other systems is coupled with the ability of that subsystem to individually trigger the disconnection of the smart breaker in a fault scenario. This principle applies further up the system architecture. For example, an individual breaker may perform all its features without being connected to another breaker or the controller and the controller may continue its functions without internet and without connection to most breakers (i.e., it does need to be connected to a breaker to turn it off for a load shed event).

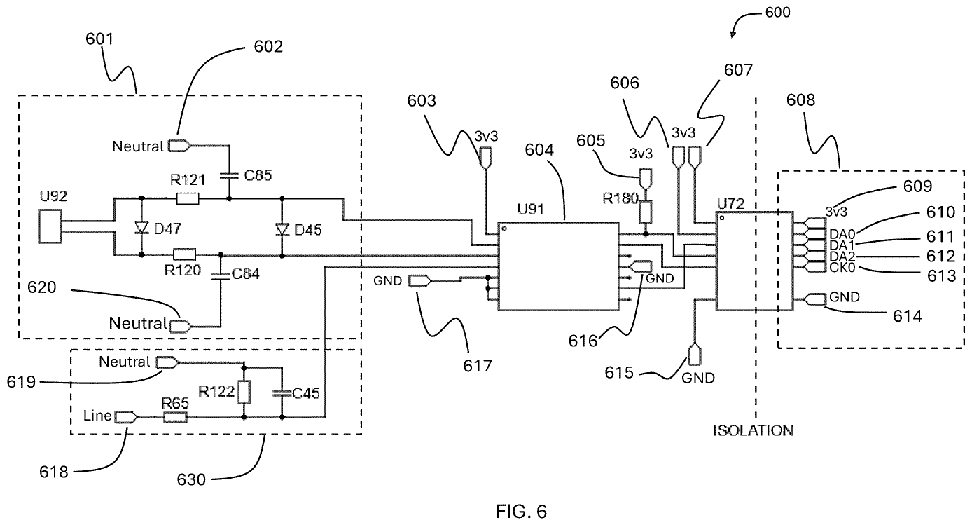

FIG. 4 is a line diagram of a subsystem 400 of a smart circuit breaker assembly 490, according to an embodiment. The subsystems 400 may include a combination of line side connections line 0 423, neutral 422, and line 1 421, as well as load side connections load 0 418, neutral 419, and load 1 420. The subsystems 400 include an alternating current (AC) power line 414, a power supply 401 (configured to rectify the AC to DC and steps the DC voltage down to a lower supply voltage that is usable by the subsystems), an arc fault sensing system 402, ground fault sensing system 406, over current fault system 407, a metering front end system 408, and a communications controller 403. The subsystem 400 communicate externally, via the communication controller 403, to a control module 404 described hereinbelow in relation to at least FIG. 5. The control module may be further configured to communicate with additional smart circuit breakers 409. For example, such communications by the network controller 507 and the communication controller 514 may be performed via isolated wired communication (See, FIG. 6 608) by using protocols such as, for example, Controller Area Network (CAN), Universal Synchronous and Asynchronous Receiver-Transmitter (USART), Universal Serial Bus (USB), MODBUS, ethernet, or any other appropriate protocols. Moreover, such communications may be performed via wireless communication protocols such as, for example, Bluetooth, Wi-Fi, Zigbee, or any other appropriate wireless methods. The subsystem 400 derives its power directly from an alternating current (AC) main 414 that may include connections to connections line 0 423, neutral 422, and line 1 421. The subsystem 400 may control the line phases 423 and 421 via electronically operated switches 405, and 413 (e.g. electromechanical relays). The subsystem 400 also monitors current and voltage waveforms through a combination of current transformers 412, 415, 411 and resistive shunts 416, and 417. The load side 410 of the smart circuit breaker is connected to the downstream circuit's load 0 418, load 1 420 and neutral 419.

According to an embodiment, the subsystem 400 of the smart circuit breaker device may be controlled by a breaker PCBA (“Breaker Board”) (See, 203 of FIG. 2). The PCBA may be configured to provide signal to latch and unlatch onboard electrically controlled switches, signal the state of the smart circuit breaker device using onboard LEDs (See, FIG. 12 LED27-30), communicate with additional breaker 409, as well as communicate a control board 590 of FIG. 5 discussed hereinbelow. The circuit breaker device may also contain specialized circuitry, such as GFCI circuitry 406 to sense, and AFCI circuitry 402 to sense arc faults. Such circuity shall conform to appropriate safety guidelines and requirements, for example, but not limited to, the guidance as set out in UL 943 (Underwriters Laboratory).

FIG. 5 is a line diagram of a subsystem 500 of a smart circuit breaker assembly including a control board 590 or module assembly, according to an embodiment. The Control Printed Circuit Board Assembly (CPCBA) or (“Control Board”) 590 may include a network controller 507 configured to communicate with the internet via, for example, Wi-Fi, Bluetooth, ethernet, or other appropriate methods for connection to a Local Area Network (LAN) and/or Wide Area Network (WAN) 510. In addition, the network controller 507 may be configured to communicate with an isolated communications controller 514. The isolated communications controller 514 may be configured to communicate with at least one circuit breaker 515. The CPCBA 590 may also include a power supply 506 configured to receive power from an AC main 502. Such an AC main 502 may include a line 0 501, a neutral 503 and a line 1 504. The control board 500 may include metering front ends 505 and 511. Metering front end 505 may be configured to measure current and voltage through the current transformers 508 and 509, while metering front end may be configured to measure current and voltage through resistive shunts 512 and 513. The control board 590 may also be responsible for coordinating data flow between additional smart circuit breakers 515 through a communication controller 514, as well as storing the recorded data in memory for transmission to a cloud-based server via the LAN or WAN 510.

According to an embodiment, the smart circuit breaker device main control board 590 provides for accurate voltage sensing for, for example, the main power in the building or dwelling the main distribution panel is located. The main board also may have expansion capabilities to facilitate a tie into, for example, battery backups, universal power supply (UPS) systems, solar systems, photovoltaic systems, backup generators, universal power supplies, emergency power systems, lighting control systems, mechanical systems, and the like.

According to an embodiment, the smart circuit breaker device may include integrated firmware configured to interface between a cloud Internet of Things (IoT) server and the physical hardware on the smart circuit breaker device. The integrated firmware may also be configured to interface between the respective control boards of a plurality of daisy-chained smart circuit breakers. The integrated firmware may include features such as secure socket layer communication, over the air updates, error sensing and recovery, fall back/self-healing firmware patches, and unique serialization for paring and communication with the cloud servers.

The smart circuit breaker device may also include an integrated software. The front-end software is intended for desktop computer and mobile smartphone use. This may include an IOS, Android, and/or HTML based software application. The software application may communicate with the cloud server and display data obtained for the user either on the desktop computer, mobile smartphone, or on the integrated screen. This data may include, but is not limited to the electrical current, power and usage monitored by the circuit breakers, their respective waveforms, which circuits are active, as well as and predictions on future energy needs or habits. The software also allows for the user to designate timers and schedules to be set, the breakers to be switched “on” and “off,” and for alerts of fault detections as well as power outages to be sent to the respective devices. The applications will require user login and authentication and may or may not have certain features behind paywalls.

While specific component values and or component model numbers may be referenced in the below descriptions of FIGS. 6-15 , it should be understood that these component values and or component model numbers may vary based on a particular application. As such, it should be understood that a range of component values and a plurality of makes and models of components may be appropriate, and that the component values and or model numbers referenced herein below are examples.

FIG. 6 is a circuit diagram of an example metering front end (MFE) 600 (See, 408, 505, 511), according to an embodiment. The MFE 600 is electrically connected to the line 618 and neutral 619 through two main systems. The first of the two main systems is the current measuring system 601. The current measuring system includes a 0.02 milli-Ohm (mΩ) (or other appropriately sized) resistive shunt U92, transient voltage suppression diodes D47, D45, and resister-capacitor (RC) filter circuits made up of R121 and C85, and R120 and C84, respectively. The measuring system 601 is configured such that current flows through the resistive shunt U92, this current signal is subsequently converted into a voltage signal in accordance with Ohms Law. This current signal is then conditioned by the filter circuits R121 and C85 and R120 and C84 which are arranged in a low pass RC filter configuration. Such a filter configuration may utilize resisters of 510 Ω and capacitors of 68 nano-farad (nF) or other appropriately sized components.

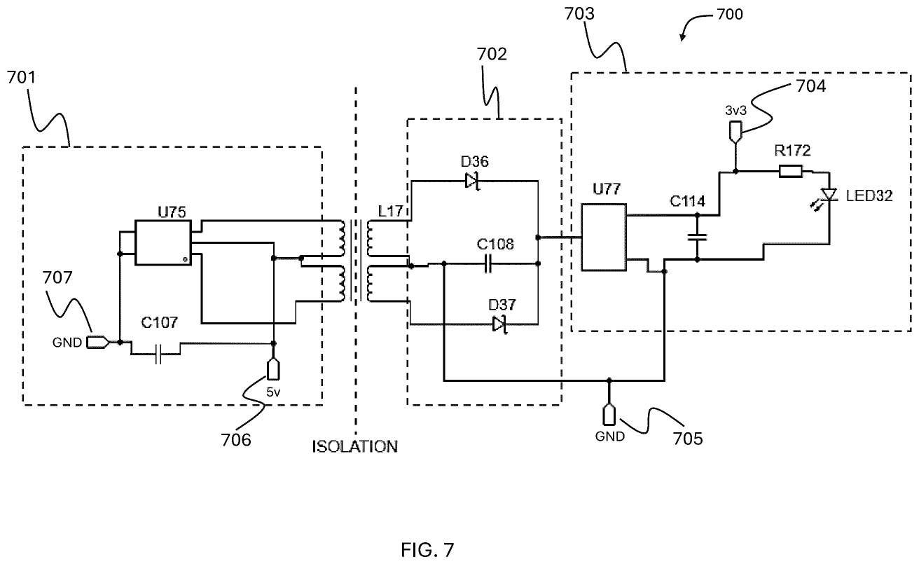

The second of the two main systems of the MFE, is the voltage measuring system 630. The voltage measuring system 630 is configured as a resistive divider. Resistor R65 (e.g., 2 Megaohms (MΩ)) and R122 (e.g., 510 Ω) are connected to the mains AC line 618 and neutral 619. The voltage is sampled over resistor R122 and smoothed using a capacitor C45 (e.g., 68 nF). Both systems 600 and 601 are connected to an energy metering integrated circuit (IC) 604 such as, for example “BL0942” or any other appropriate metering IC. This IC 604 is interfaced to a highspeed digital isolator IC U72. IC U72 may be any IC capable of bidirectional or unidirectional communication (e.g., 131U31” or “ISO7741”) and should communicate using a protocol (e.g., USART or Serial Peripheral Interface (SPI)) to the microcontroller 1201 of FIG. 12, discussed in more detail hereinbelow. IC U72, along with an isolated power supply (See, FIG. 7 discussed hereinbelow) ensure that each phase being metered remains isolated from the system. The microcontroller 1201 may be responsible for performing energy calculations such as; converting an analog to digital integer and/or into a voltage reading or current reading or this may be performed on the metering IC 601.

The metering front end 600 also includes an isolated wireless communications system 608. The communications system 608 may include of digital binary outputs 611 and 609, the USART receiver 613, a transmitter 610, and a clock signal 612. The system derives its supply from the 3.3V rail 609 and is grounded at GND 614.

FIG. 7 shows an isolated power supply circuit 700, according to an embodiment. Such an isolated power supply circuit may be comprised of three power supply circuits 701, 702 and 703. The power supply circuit 701 draws power from the 5 volt (V) rail 706 and is decoupled using an appropriately sized capacitor C107 such as 10 micro-Farad (μF). Transformer U75 is an appropriately sized high frequency transformer such as, for example, the “SN6505” transformer, but it should be understood that any appropriately sized high frequency transformer may be used. Transformer U75 drives a 1:1 transformer L17 that is capable of high frequency switching and has the appropriate dielectric rating e.g., 1500V. Power supply circuit 702 may include a plurality of rectification components configured to rectify the high frequency AC provided by the transformer L17. Diodes D36 and D37 are appropriately sized highspeed diodes (such as, for example, “IN5819”) configured to rectify the voltage. This voltage is smoothed using capacitor C108 (e.g., 10 μF). Power supply circuit diagram 703 is a linear voltage regulator comprising the regulator IC U77 (such as, for example, the “LM1117”) and supporting components such as capacitor C114. An indicator LED LED32 is connected via a current limiting resistor R172 (e.g., 32022) to the 3.3V supply line 704.

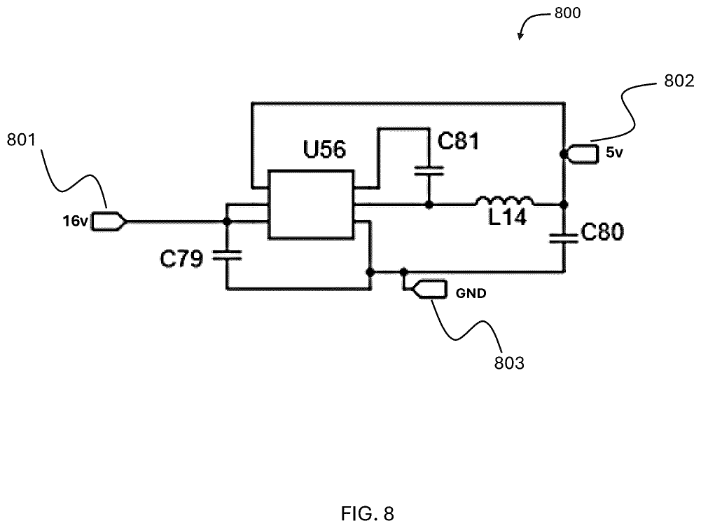

FIG. 8 is a circuit diagram of a buck step-down voltage regulator 800, according to an embodiment. The buck step-down voltage regulator 800 derivates its power from the 16V rail 801 and is connected to the system ground (GND) 803. The regulation IC U56 (e.g., “AP63205”) is an asynchronous buck converter configured to receive an input voltage range of 3.8V to 32V and output a stable 5V. Capacitors C81 and C79 are appropriately sized decoupling capacitors (e.g., 10 μF-22 μF) and inductor L14 is an appropriately sized inductor (e.g., 4.7 μH). The buck step-down voltage regulator 800 provides the breaker boards with a stable 5V via a connection 802 to a 5V rail.

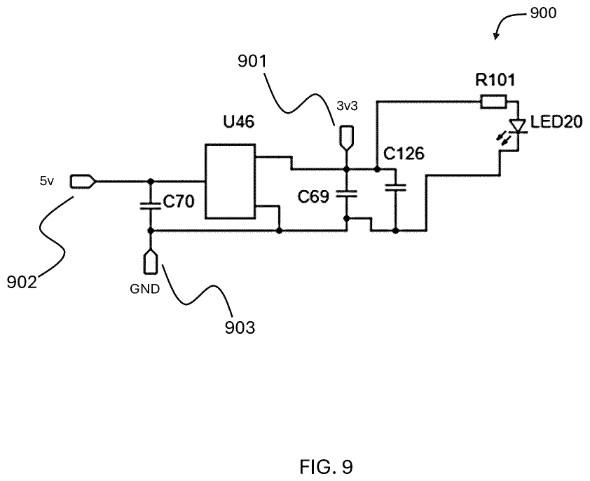

FIG. 9 is a circuit diagram of a 3.3V regulator circuit 900, according to an embodiment. The regulator circuit 900 receives its power form the 5V rail 902 and is decoupled via capacitor C70 (e.g., 10 μF-22 μF). The regulator circuit 900 utilizes a low drop out linear voltage regulator IC U47 (e.g., “LM1117”) that outputs a stable 3.3V which is in turn connected to the 3.3V rail and decoupled by capacitors C69 and C126 (e.g., 10 μF-22 μF). Regulator circuit 900's stable operation is indicated by LED LED20 which is current limited by resistor R101 (e.g., 32022).

FIG. 10 is circuit diagram of semi-conductor-based relay driver circuit 1000, according to an embodiment. Semi-conductor-based relay driver circuit 1000 uses a 3.3V binary input 1009 to drive a thyristor 1001, or other similar device, into the conducting state. The resistor 1003 is designed to handle a high energy pulse to protect and safely drive the electromagnetic coil of the relay 1002. Relay 1002, e.g., a 12V-48V single pole double throw relay, may be connected to the line 1007 and load 1008 circuits. A respective semi-conductor-based relay driver circuit 1000 may each act as respective switches 405 and 413 of FIG. 4.

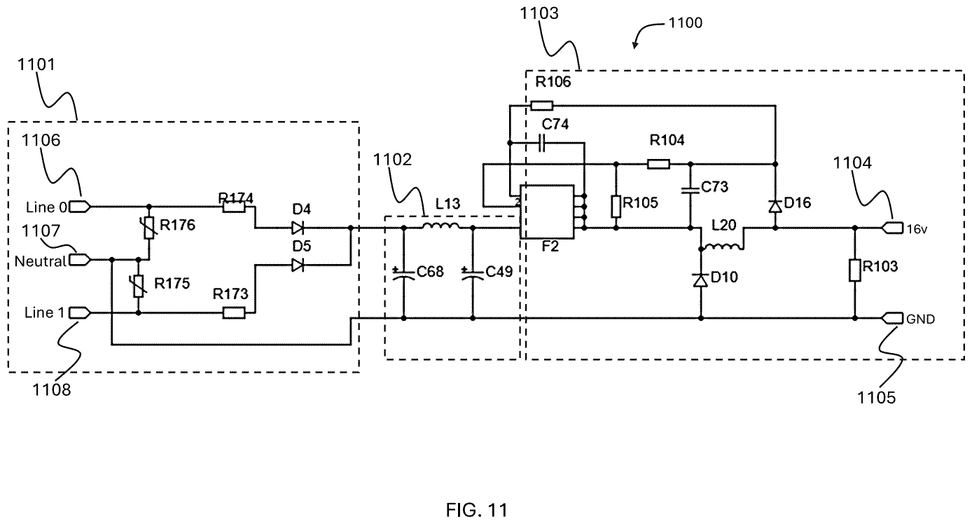

FIG. 11 is a circuit diagram of a high-voltage buck converter circuit 1100 configured to step down 100V-240V AC to 16V direct current (DC), according to an embodiment. Converter circuit 1100 is not isolated. Each smart circuit breaker may have one high-voltage buck converter circuit 1100, but the control module may not. The control module may have an off-the-shelf isolated power supply configured to supply an appropriate voltage for operation (e.g., 5V DC). The high-voltage buck converter circuit 1100 derives its power from the AC lines 1106 and 1108 and is grounded to both the system ground 1105 and the neutral 1107. Transient voltage suppression is provided by metal oxide variable resistors R176 and R175 (appropriately sized for the mains voltage) and over current protection provided by fusible resistors R174 and R173 (e.g., 1022). The input is half wave rectified by diodes D4 and D5 (e.g., “1N4005”), and is smoothed by capacitors C68 and C49 (e.g., 4 μF-10 μF). The switching regulator IC F2 (e.g., “LNK3206”) provides a stable output voltage of 16V to the 16V rail 1104. Supporting components such as capacitors C74, C73, resistors R106, R104, R105, R103, diodes, D10, D16, and inductor L20 may be chosen according to the datasheets associates with the switching regulator IC F2.

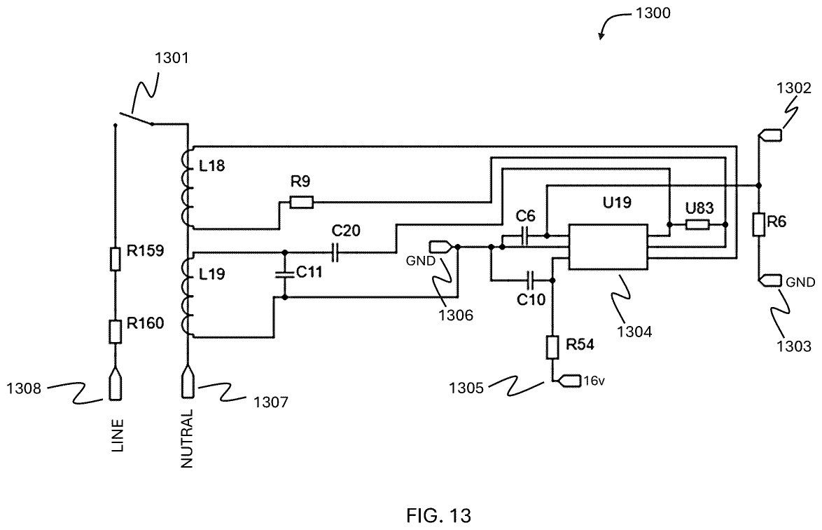

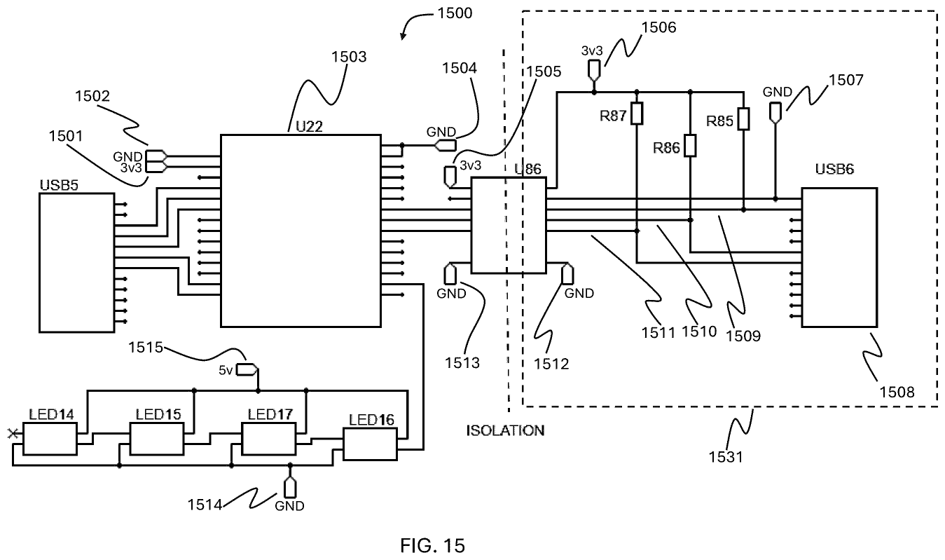

FIG. 12 is a circuit diagram of a microcontroller (MCU) (e.g., “STM32G071”) circuit 1200, according to an embodiment. MCU 1201 may be configured to perform a plurality of tasks, such as, for example, control indicator LEDs LED27-30, receive instructions from the controller board (See, FIG. 15 1503, discussed hereinbelow) via an isolated communications bus 1206, communicate with metering front end circuit 600 of FIG. 6, electronically control switches such as relays 204 of FIG. 2, as well as electronically control the ground fault and arc fault circuitry of FIG. 13, discussed hereinbelow. The MCU 1201 draws its power from the 3.3V rail 1222, and also connects to the system ground 1221. The MCU 1201 uses inputs 1218 and 1217 to sense the presence of line voltage on the load side of the relays 204 of FIG. 2. This sensing line side voltage is used to determine the state of the relay 204 independently from the operation of the relay 204. A programming interface may be present in the form of exposed test points on a printed circuit board and connected to the serial wire data input/output 1227, clock 1226, reset 1225, ground 1224 and 3.3V rail 1203. The reset line 1225, system ground 1224, along with general pins 1252 and 1253 are connected to a highspeed digital isolator 1206 and connector USB4. This enables communication with other breakers and the control module using a protocol such as USART, SPI, CAN or other appropriate protocols. Diode D48 (e.g., “1N4001”), ensures the reset line is unidirectional. The communication lines 1252 and 1253 may be connected to pull up resistors R115 and R117 (e.g., 5 kΩ-10 kΩ), and are in series with the 3.3V rail 1204. The MCU 1201 utilizes inputs 1210-1211 to receive ground fault signals, inputs 1212-1213 to receive data from the meter ICs via the on board communications bus and utilizes outputs 1214-1216 to issue binary commands to the relay driving circuits. The microcontroller 1201 is also responsible for securely communicating to the host controller (or hub) via a wired or wireless connection but does not directly connect to the internet. The microcontroller 1201 may also control the relays (or other electromechanical or solid state switch/relay) and monitors for inputs for the actuation of these from the control board embodied in FIG. 5.

FIG. 13 is a circuit diagram of ground-fault-interrupter (GFI) sensing circuit 1300, according to an embodiment. GFI sensing circuit 1300 utilizes current transformers L18 and L19 to sense any differential faults. A push button 1301 may be coupled to the ground fault sensing IC 1304 U19 (e.g., “FAN 4149”) and is used to initiate a system test for the GFI IC 1304 to ensure that it is working properly. A test signal may be generated using appropriately sized resistors R159 and R160 that are connected to line 1308 and neutral 1307. Resistors R9, R54, R6, U83, and capacitors C6, C10, C20 and C11 are all supporting components selected based on the recommended components from the manufacturer of the IC 1304. IC 1304 derives its power from the 16V line and is current limited by resistor R54 (e.g., typically a 1 kΩ). The ground fault interrupter IC 1304 issues is binary fault signal via 1302 to be received by the MCU 1201 of FIG. 12.

FIG. 14 is a circuit diagram of a GFCI circuit 1400 that utilizes resistive shunts R181, R182 and R183 for sensing, according to an embodiment. The system requires these resistive shunts R181, R182 and R183 to be precision trimmed and of a resistance as low as 10 μΩ or lower. The GFCI circuit 1400 is galvanically isolated by a 1:1:1:1 transformer L21. Each resistive shunt R181, R182 and R183 may have a potentiometer R186, R187, R184 utilized to calibrate the GFCI circuit 1400 to ensure the deferential current in a no fault scenario is lower than 3 milliamps (mA). Operational amplifiers U93 and U94 are appropriately selected operational amplifiers configured as amplifiers and/or filters to ensure reliable sensing of ground faults.

FIG. 15 is a circuit diagram of an internet communication circuit 1500, according to an embodiment. The communication circuit includes the universal-serial-bus (USB), Wi-Fi and Bluetooth capable microcontroller (NMCU) 1503 configured to communicate with the cloud.

The communication circuit 1500 interfaces with the smart circuit breakers through the isolated communication bus 1531 using a connector USB6 1508 that may be in the style of “USB-C” connector, and to a computer or programmer via an onboard USB controller USB5. The isolated communications bus comprises a highspeed digital isolator U86, communication lines 1511, 1510, 1509 and pull up resistors R87, R86, R85 (e.g., 5 kΩ-10 kΩ). The communication circuit 1500 derives its power from the 3.3V rail 1506 and ground 1512. The NMCU 1503 is configured to provide firmware updates to the microcontrollers (See, FIG. 12 1201) on the smart circuit breakers, as well as allow the smart circuit breakers to communicate with the cloud. The communication circuit 1500 may also be configured to act as an information buffer, locally storing information in the event connection to the cloud has been lost, the communication circuit 1500 may then display its status by illuminating LEDs LED14-17.

Additional embodiments may include a built-in artificial intelligence (AI) component into the smart circuit breaker. This AI component may collect data from the user's controls, as well electrical data from the smart circuit breaker and associated distribution system. The AI component may build language models (e.g., large language model) and neural networks from the data collected and use these language models to optimize energy efficiency within its own branch circuit, or in larger applications, optimize efficiency within the electrical distribution panel. In addition, the AI component may be able to monitor the condition of the smart circuit breaker. For example, if the smart circuit breaker's internal mechanisms are becoming worn out or are otherwise past their rated number of trips, the AI component may be able to detect this and inform the user.

In addition, in the event of a fault within the circuit, the AI component may be able to detect a location of the fault and inform the user where the fault has likely occurred, according to an embodiment. In such an embodiment, the AI component may be able to distinguish between different types of faults, including but not limited to arc faults, ground faults, short circuits and similar.

According to an embodiment, the AI component may also be able to communicate with an internet server, allowing the device to analyze historical power consumption in the area. This may allow the smart circuit breaker to make decisions about its own load based on, for example, historical high energy consumption during particular seasons, such as extreme hot or cold temperatures in the area.

Moreover, according to an embodiment, the AI component may be able to connect to a weather service in order to predict likely power outages, power surges, or similar, and make adjustments to its own load or inform the user.

The AI component may also be able to analyze the electrical characteristics of its circuit during a fault and provide that information to the user. This may assist in identifying why faults occurred and prevent them from occurring in the future.

In another embodiment, the AI component may interface with a smart device (for example, an internet of things (IoT) sensor) connected to important appliances or machineries within the load of a particular circuit. The AI component may be able to communicate with these devices, which may provide real time information to the smart circuit breaker on specific performances of particular appliances. In another embodiment, the smart circuit breaker may be configured to communicate with additional smart electrical devices, including but not limited to a smart switch. In such example embodiments, the smart circuit breaker may be in communication with a plurality of smart switches connected to its circuit. The smart circuit breaker may be able to control these smart switches. For example, if the smart circuit breaker is rated for a specific amperage, and it knows that when smart switch “A” turns on, it will draw enough power that if smart switch “B” is also turned on the total current draw would be more than the circuit is rated to supply. Then, the smart circuit breaker may decide to turn off smart switch “B” in order to allow the devices on the load side of smart switch “A” to operate.

In additional embodiments, the smart circuit breaker may be configured to be a “main” circuit breaker for a particular distribution panel. The main circuit breaker for an electrical distribution panel is connected to the line side of each of the branch circuit breakers within the panel. In this configuration, the smart circuit breaker may be configured to record data from each of the branch circuit breakers and associated branch circuits. Such an embodiment may also be configured where the main circuit is the smart circuit breaker and is able to control power distribution to the legacy, i.e., “non-smart,” circuit breakers on the panel, as well as communicate with additional smart circuit breakers within the panel. This may provide useful information to the user, such as load balancing within the panel.

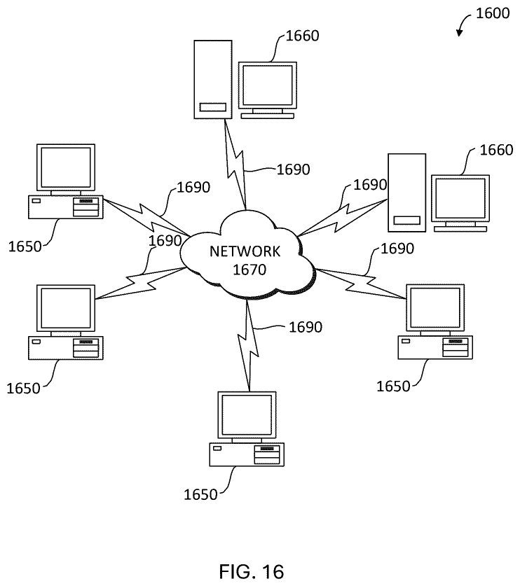

An example implementation of smart circuit breaker may be implemented in a software, firmware, or hardware environment. FIG. 16 illustrates one such example digital processing environment 1600 in which embodiments of system may be implemented. Client computer(s)/device(s) 1650 and server computer(s)/device(s) 1660 provide processing, storage, and input/output (I/O) devices executing application programs and the like. Client computer(s)/device(s) 1650 may be linked 1690 directly or through communications network 1670 to other computing devices, including other client computer(s)/device(s) 1650 and server computer(s)/device(s) 1660. The communication network 1670 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Communication network 1670 may also be a virtual private network (VPN) or an out-of-band (OOB) network or both. Further, communication network 1670 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, client computer(s)/device(s) 1650 may include nodes which run user applications that enable a user to communicate with an application to determine whether a user meets a work requirement.

Client computers of the computer-implemented system may be configured with a trusted execution environment (TEE) or trusted platform module (TPM), where the application may be run and digital assets, e.g., held in digital wallet(s). For example, firmware/software components of the smart circuit breaker may be paired with a smart circuit breaker client application (via, for example, Wi-Fi or Bluetooth) that can be used to monitor, manage and execute diagnostic components of the smart circuit breaker software. Diagnostic analysis of the circuit breaker, branch circuit, other smart circuit breakers, electrical distribution, or downstream appliances may be performed via the firmware/software components of the smart circuit breaker. The smart circuit breaker client application can be executed from a TEE or TPM to improve security and user privacy.

FIG. 16 illustrates a computer network or similar digital processing environment 1600 in which embodiments of the present disclosure may be implemented.

Client computer(s)/devices 1650 and server computer(s) 1660 provide processing, storage, and input/output devices executing application programs and the like. The client computer(s)/devices 50 can also be linked through communications network 1670 to other computing devices, including other client devices/processes 1650 and server computer(s) 1660. The communications network 1670 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

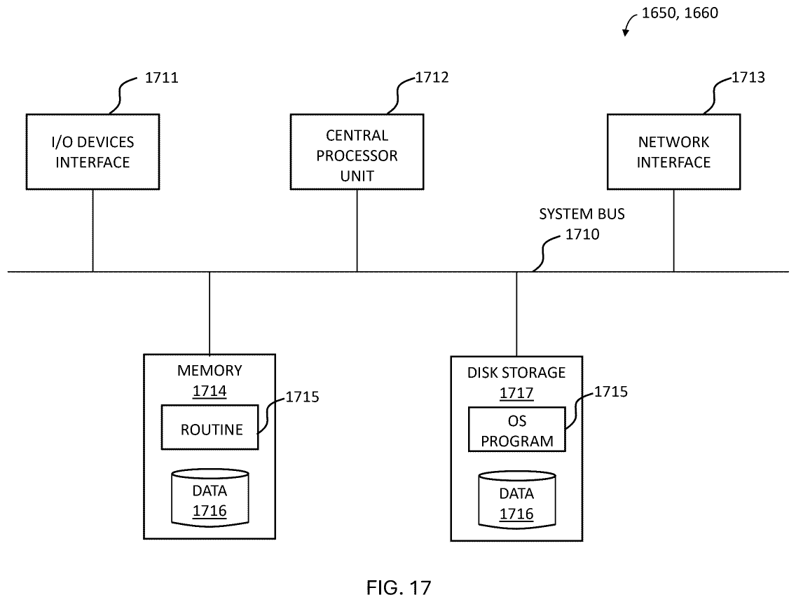

FIG. 17 is a block diagram of any internal structure of a computing/processing node (e.g., client computer(s)/device(s) 1650 or server computer(s)/device(s) 1660) in the processing environment 1600 of FIG. 16, which may be used to facilitate displaying audio, image, video, or data signal information. Each computer/device 1650, 1660 in FIG. 16 may contain a system bus 1710, where a bus is a set of actual or virtual hardware lines used for data transfer among components of a computer or processing system. System bus 1710 may essentially be a shared conduit that connects different elements of a computer system (e.g., processor, disk storage, memory, I/O ports, etc.), thereby enabling transfer of data between elements or components.

Continuing with FIG. 17, attached to system bus 1710 is an I/O device interface 1711 for connecting various input and output devices (e.g., keyboard, mouse, touch screen interface, displays, printers, speakers, audio inputs and outputs, video inputs and outputs, microphone jacks, etc.) to a computer/device 1750, 1760. Network interface 1713 may allow a computer/device to connect to various other devices attached to a network, for example network 1670 of FIG. 16. Memory 1714 may provide volatile storage for computer software instructions 1715 and data 1716 used in some embodiments to implement software modules/components of the system. Software components 1715 of the smart circuit module(s)/engine(s)/system(s), software components, smart circuit breaker system firmware and software, AI model, digital twin of the smart circuit breaker, AI component, the energy efficiency policy enforcement system, a minimax recursive algorithm, encoder/decoder, Trusted Execution Environment (TEE), oracle, wallet interface, applets, authentication site, cybersecurity controller, service applications, and the like) described herein may be configured using any programming language known in the art, including any high-level, object-oriented programming (OOP) language, such as Python or Solidity. The system may also include instances of a scoring engine and/or encoders/decoders, which can be implemented by, e.g., a server 1660 or a client that communicates with the server 1660, using, for example, secure sockets layer (SSL), Hypertext Transfer Protocol Secure (HTTPS), or any other suitable protocol known to those of skill in the art.

In an example embodiment, software components 1615 of the smart circuit breaker system may be executed in a virtual machine. The smart circuit virtual machine may be encapsulated, via a packetizer, and can be configured to enable tamper detection. The encapsulation can help ensure that it is not tampered with. In a preferred embodiment, at least portions of the smart circuit virtual machine may be executed from a trusted platform module (TPM) or trusted executed environment (TEE). The smart circuit virtual machine can execute via a client app and/or server system. The smart circuit virtual machine may be configured to record data and monitor data from each of the branch circuit breakers and associated branch circuits, and can be configured to control power distribution to the legacy “non-smart” circuit breakers on the panel, as well as communicate with additional smart circuit breakers within the panel. This may provide useful information to the client app, such as load balancing within the panel to monitor/manage and for diagnostic purposes.

In an example embodiment, the smart circuit breaker system may incorporate a digital twin implementation for fault prediction. In an example implementation, IoT architecture may be used to connect the physical breaker to a virtual model. The physical smart circuit breaker may be configured to collect real-time sensor data (e.g. current, voltage, temperature, trip status) and communicate it through its supported interfaces (CAN bus, USART, SPI, USB, or Ethernet) to a central system. On the other side, a cloud-based digital twin service can be configured to maintain a virtual replica of the breaker, mirroring its state and running simulations. This twin may incorporate both a physics-based model of the breaker's behavior and an AI-driven analytics model for predicting faults.

In an example, the overall flow may include (i) data acquisition: the smart circuit breaker's embedded controller can be configured to gather real-time data and event logs; (ii) communication layer: data may be transmitted via supported protocols (e.g. CAN or USART to a gateway, or ethernet/USB to a network) to the digital twin platform; (iii) digital twin model: a cloud-hosted model represents the breaker's state, updates with incoming data, and can simulate response to various conditions; (iv) AI analytics: an AI component processes historical and real-time data from the twin to predict faults and recommend maintenance; (v) user/control Feedback: Predictions or alerts are fed back to operators (or even to the control module) for proactive action. This architecture can help ensure that the backwards-compatible smart circuit breaker (designed to fit legacy panels) is augmented with modern IoT and AI capabilities without altering the existing electrical panel infrastructure.

In an embodiment, the smart circuit breaker may be implemented with an embedded system. In an example implementation, the smart circuit breaker may be implemented with a microcontroller or SoC that interfaces with current/voltage sensors and the breaker's trip mechanism. In this way, the smart circuit breaker may be configured to support multiple communication protocols for flexibility.

In one example, the smart circuit breaker can be configured to interface with other circuit breakers or a host controller via CAN (Controller Area Network) 1670 to enable robust multi-drop networking. In an example implementation, breakers in a panel can be connected via a CAN bus, exchanging status and measurements. For example, the breaker can interface via the CAN-based protocol to broadcast its sensor readings and receive control signals. CAN may be reliable in noisy electrical environments.

In an example, the smart circuit breaker can be configured to interface with other circuit breakers or a host controller via USART (Universal Synchronous/Asynchronous Receiver/Transmitter). It can be used in asynchronous mode (like RS-232/RS-485 communication) to connect to a local controller or gateway. For instance, a panel might have a UART bus (or an RS-485 multi-drop network) where each breaker reports data to a master controller. In synchronous mode, it could interface with certain synchronous serial links if needed.

In an example, the smart circuit breaker can be configured to interface with other circuit breakers or a host controller via SPI (Serial Peripheral Interface). SPI may be configured to enable a dedicated high-speed link to a panel controller. For example, the central module may be configured to include SPI bus with chip-select lines to each breaker, it can poll them for data. While SPI is typically less common for multi-device panel networking (due to wiring complexity), it can be used internally or for stacking multiple breakers with a ribbon cable in a controlled environment.

In an example, the smart circuit breaker can be configured to interface with other circuit breakers via USB: The breaker might include a USB port for configuration or local data access. The USB interface can be used to update firmware 1715, retrieve detailed logs, or perform diagnostics on the smart circuit breaker.

In an example, the smart circuit breaker can be configured to interface with other circuit breakers or a host controller via Ethernet. The Ethernet interface can allow the breaker (or the central panel controller) to connect directly to IP networks 1670. In one embodiment, the breaker could have an RJ45 port or connect to an Ethernet switch, enabling direct communication to the cloud or a local network. This could use protocols like MQTT or HTTP/REST to send data to the cloud service.

In an example, the smart circuit breaker can be configured to interface with a Control Module/Gateway. In an example, rather than connect each breaker directly on Ethernet, there a control module can be implemented in the panel acting as a gateway. This module could communicate with breakers over CAN or UART, then aggregate and send data to the cloud via Ethernet or a cellular/Wi-Fi connection. The control module may be configured to ensure minimal changes to legacy panel wiring to interface with the smart circuit breakers and a single gateway device. The gateway can use an IoT protocol (MQTT, AMQP, etc.) to push data to the cloud in a secure, efficient manner.

The smart circuit breaker's firmware 1715 can be configured to format sensor readings (e.g. RMS current, voltage, breaker on/off state, trip events, internal temperature) into messages. For instance, on a CAN bus it might send CAN frames at regular intervals with measured values and immediately send an alert frame if a trip occurs. Using USART/RS-485, it may be configured to use a Modbus RTU protocol or a custom protocol to allow the gateway to poll data from each unit. The communication preferably is real-time enough to reflect dynamic conditions (perhaps on the order of seconds or faster for critical fault indicators).

In an embodiment, the smart circuit breaker is preferably backward compatible and is configured to perform all normal protection functions autonomously (interrupting on overloads or short-circuits), even if communications fail. The digital twin and AI system adds a monitoring and prediction layer on top, but does not replace the core safety functionality. This failsafe design can help ensure that the legacy interoperability and compliance is not compromised.

In the cloud 1660, a digital twin representation may be implemented for each physical smart circuit breaker. In an example implementation, the smart circuit breaker digital twin may be configured as a virtual model that mirrors the smart circuit breaker's condition and can simulate its behavior. In an example, the smart circuit breaker, the twin may be configured with (i) real-time state variables: e.g. breaker on/off/tripped status, current flowing through it, voltage, temperature of breaker (if sensor provided), number of operations (trip count), etc. Preferably, these are updated in real time from the incoming data stream; (ii) static properties: e.g. breaker rating (ampere rating, trip curves, model type), communication ID, installation location in the panel; (iii) behavioral models: the twin encompasses the breaker's electrical and mechanical behavior. For example, the time-current trip characteristic may be encoded in the model. This can be configured as a function or lookup curve provides a certain current overload and calculates how long until the breaker would trip. The model also may incorporate the effect of temperature (since thermal trip elements respond faster when warm) and wear (a heavily used breaker might have slightly different characteristics).

In an example implementation, the smart circuit breaker digital twin can be implemented with a simulation engine 1715 configured to execute what-if simulations by injecting hypothetical inputs. In one example, the simulation engine may be configured to simulate a fault scenario by inputting an over-current condition into the twin's model. The twin can be configured to then use the stored trip curve and current state to predict if and when a trip would occur, without actually cutting power. These simulations can cover rare failure scenarios or extreme conditions that are undesirable to test on the real system directly. Digital twins for the smart circuit breakers may be configured to as stand-ins to run various failure simulations and proactive maintenance strategies, providing insight into asset health and performance under predefined conditions.

In an example embodiment, the digital twin may be integrated with the broader system model for the host controller. For example, if multiple breakers communicate (say via CAN), the twin network can simulate coordination between breakers (e.g. selective tripping, load balancing). However, at the individual level, the breaker's twin focuses may be on its own performance.

The digital twin platform may be configured using cloud IoT services to enable modeling relationships and live data binding of state data. In an example embodiment, in response to the smart circuit breaker sending new state data, the cloud twin may be updated to reflect that current state. In another example, an operator may use the twin to simulate a scenario (say, “what if the current rises to 150% of nominal?”), the twin can compute the outcome and predict/advise on whether the breaker would trip.

On top of the basic simulation model, AI-driven analytics component, such as an AI model for fault prediction and diagnostics may be implemented. In an example, the AI model may be configured to ingests data from the twin (both real-time streaming data and historical records) to predict faults or anomalous conditions before they happen.

The AI model may use a predictive analytics and anomaly detection configuration to predict faults or anomalous conditions. In this example, using machine learning algorithms, the system can learn what “normal” operation looks like and detect subtle deviations. For instance, an anomaly detection model (like an autoencoder or isolation forest) could continuously monitor the current waveforms or load patterns. If the breaker starts to see unusual spikes, oscillations, or patterns that historically precede a fault (e.g. an arc fault or an impending overload), the AI model can be configured to create an alert or flag it. In this way, arc-fault detection may be provided. Arc faults produce high-frequency noise and intermittent current signatures. An AI model (such as an LSTM neural network or a trained classifier) can recognize the signature of an arc fault from the current sensor data and alert the system, possibly even before the arc builds to a dangerous level.

The AI model may be configured to integrate supervised learning trained on data from many breakers or simulations. For example, a neural network or gradient-boosted tree model could be trained to predict the probability of different fault types (overload vs. short-circuit vs. arc) based on sensor inputs. It could also estimate the Remaining Useful Life (RUL) of components—e.g. predicting when the breaker's mechanical spring or contacts might fail based on number of operations and stress.

To enhance fault prediction, in an embodiment, the system may leverage generative models, such as GANs (Generative Adversarial Network) or simulators to implement synthetic fault scenarios that are rare in real life. By augmenting training data with these simulated failures, the AI model can be more robust in recognizing and handling unexpected conditions. In this way, the digital twin environment can be implemented to simulate various failure scenarios (even extreme or rare ones) to test how the breaker/twin responds, and the AI model can be configured to learn from those responses. This improves failure prediction accuracy by exposing the model to a wider range of conditions. The digital twin's ability to run virtual stress tests combined with AI means it can anticipate faults that haven't even been seen in the real device yet. One of the key benefits of a digital twin is the ability to simulate fault scenarios digitally. This helps both in testing the system and in training the AI model.

In an embodiment, the digital twin acts not only as a real-time mirror, but also as a sandbox for experimentation. By running failure simulations on the twin and leveraging AI to analyze them, the smart circuit breaker system can predict major failures and incidents through data-driven simulations and suggest preventative actions.

In an embodiment of the smart circuit-breaker, the AI model may be grounded with Retrieval-Augmented Generation (RAG). RAG can be used to strength the AI model (e.g. LLM) in the smart circuit-breaker digital twin by providing the LLM with context awareness and grounded reasoning. RAG may be configured to fetch the right technical data (device specs, logs, breaker curves, firmware notes, standards.) In an example implementation, RAG can enable tight coupling between raw telemetry/logs and high-value outputs like fault simulations, setting recommendations, and auditor-ready data.

An example RAG configuration may secure bindings in the digital-twin stack, which can help transform heterogeneous data (specs, trip curves, waveforms, settings, field notes) into (a) simulation inputs, (b) parameter updates, and (c) clear, sourced explanations. The LLM may be configured as a grounded planner/generator to generate simulation input packs (the “arguments” that the digital twin simulator needs): e.g. fault_type, fault_location, R/X, source_impedance, load_mix, ambient, breaker_curve_id, setting_candidates.

In an example mobile implementation, a mobile agent implementation of embodiments may be provided. A client-server environment may be used to enable mobile services using a network server, e.g., server 1660. It may use, for example, the Extensible Messaging and Presence Protocol (XMPP) protocol, or any other suitable protocol known to those of skill in the art, to tether an engine/agent 1715 on a user device 1650 to a server 1660. The server 1660 may then issue commands to the user device on request. The mobile user interface framework to access certain components of computer-implemented system may be based on, e.g., XHP, Javalin, and/or Wireless Universal Resource File (WURFL), or other suitable known framework(s), interface(s), or combinations thereof. In another example mobile implementation for the iOS operating system (OS) and its corresponding application programming interface (API), the Cocoa Touch API may be used to implement the client-side components 1715 using Objective-C or any other suitable known high-level OOP language that adds Smalltalk-style messaging to the C programming language.

Disk storage 1717 may provide non-volatile storage for computer software instructions 1715 (equivalently “OS program”) and data 1716 may be used to implement embodiments of smart circuit. The smart circuit may include or interface with disk storage accessible to a server computer 1660. The server computer may maintain secure access to records associated with the system. Central processing unit (CPU) 1712 may also be attached to system bus 1710 and provide for execution of computer instructions. In one example embodiment, the CPU 1712 is a secure processor implemented as a dedicated microprocessor configured to execute a compliance enforcement system. In some embodiments, processor routines 1715 and data 1716 may be computer program products. For example, aspects of the system may include both server-side and client-side components. In other embodiments, authenticators/attesters may be contacted via, e.g., blockchain systems, instant messaging applications, video conferencing systems, VoIP (voice over IP) systems, etc., all of which may be implemented, at least in part, in software 1715, 1716. Further, in yet other embodiments, client-side components interfacing with the system may be implemented as an application programming interface (API), executable software component, or integrated component of the OS configured to provide access to an electronic wallet on a Trusted Platform Module (TPM) executing on a client device 1750.

In an embodiment, software implementations 1715, 1716 may be implemented as a computer-readable medium capable of being stored on a storage device 1717, which provides at least a portion of the software instructions for the system. Executing instances of respective software components of the system, may be implemented as computer program products 1715, and may be installed by any suitable software installation procedure, as is well known in the art. In another embodiment, at least a portion of the system software instructions 1715 may be downloaded over a wired and/or wireless connection via, for example, a browser SSL session or through an app (whether executed from a mobile or other computing device). In other embodiments, the system software components 1715 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art).

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A smart circuit breaker system comprising:
a smart circuit breaker including:
a line side connection to a power distribution panel bus, a load side connection to at least one branch circuit, and at least one relay coupled to a line side of the at least one branch circuit; and
a printed circuit board assembly, the printed circuit board assembly comprising a processor and a memory with computer code instructions stored thereon configured to cause the processor to:
perform at least one of: control operation of the at least one relay, record electrical characteristics through the smart circuit breaker, and provide at least one network connection to the smart circuit breaker.

2. The smart circuit breaker system of claim 1, wherein the smart circuit breaker further comprises at least one sensing coil operatively coupled to the at least one relay and the printed circuit board assembly, the at least one sensing coil configured to provide a measurement of current flow to the branch circuit to the printed circuit board assembly.

3. The smart circuit breaker system of claim 1, wherein the smart circuit breaker further comprises at least one resistive shunt operatively coupled to the at least one relay and to the printed circuit board assembly, the at least one resistive shunt configured to provide a measurement of at least one of current and voltage to the branch circuit to the printed circuit board assembly.

4. The smart circuit breaker system of claim 1, wherein the processor and the memory with computer code instructions stored thereon are further configured to cause printed circuit board assembly to at least one of:
(i) record at least a measurement and a waveform of at least one of current and voltage;
(ii) record at least one temperature measurement;
(iii) indicate the current status of the smart circuit breaker via at least one light emitting diode (LED);
(iv) enable communication between at least one additional smart circuit breaker via the at least one network connection;
(v) identify a ground fault within the branch circuit, and produce an open circuit in response to the identifying of a ground fault; and
(vi) identify an arc fault within the branch circuit, and produce an open circuit in response to the identifying of an arc fault, or any combination thereof;
wherein the smart circuit breaker is configured to produce an open circuit responsive to a value of the measured waveform.

5. (canceled)

6. The smart circuit breaker system of claim 1, wherein the at least one relay is an electro-mechanical switch configured to respectively open and close a circuit.

7. The smart circuit breaker system of claim 1, wherein the printed circuit board assembly is configured to cause the at least one relay to respectively open and close the at least one branch circuit responsive to a condition;
wherein the condition is at least one of (i) a fault scenario, (ii) a wireless communication, (iii) a wired communication, and (iv) a schedule or timer.

8. (canceled)

9. The smart circuit breaker system of claim 1, further comprising an overcurrent protection mechanism coupled to the smart circuit breaker;
wherein the overcurrent protection mechanism is at least one of: (i) thermal based, (ii) magnetically based, (iii) digitally based, and (iv) temperature based, or any combination thereof.

10. (canceled)

11. (canceled)

12. The smart circuit breaker system of claim 1, further comprising a firmware integrated to the printed circuit board assembly;
wherein the integrated firmware is configured to cause the processor and memory with computer code instructions stored thereon to at least one of:
(i) manage the at least one network connection;
(ii) operatively couple the printed circuit board assembly to the at least one relay;
(iii) interface between an internet of things (IOT) cloud server and the smart circuit breaker;
(iv) interface between the smart circuit breaker and at least one additional smart circuit breaker;
(v) maintain a secure socket layer communication, manage over the air updates, sense errors in the system;
(vi) manage integrated firmware patches; and
(vii) update at least one parameter configured to cause the at least one relay to produce an open circuit.

13. (canceled)

14. (canceled)

15. The smart circuit breaker system of claim 1, further comprising the processor and the memory and the computer code instructions stored thereon being further configured to record and store data associated with at least one branch circuit;
wherein data is at least one of: (i) power usage monitored by the circuit breaker, (ii) a current waveform (i) a voltage waveform, (iv) an indication of active circuits, (v) energy usage history, (vi) predictions on future energy needs or habits, (vii) a timer, (viii) a schedule, (ix) an indication of smart circuit breaker status, (x) a fault detection, (xi) fault detection history, (xii) an indication of temperature, and (xiii) power outages, or any combination thereof.

16. (canceled)

17. The smart circuit breaker system of claim 1, further including:
the smart circuit breaker further includes:
the memory further comprises an integrated software having an artificial intelligence component configured with a lossless audio codec configured to compress data prior to communicating with a cloud server, the integrated software further configured to:
a) provide a graphic user interface (GUI) on an IoT connected user device;
b) represent data via the GUI to the IoT connected user device;
c) communicate with the cloud server;
d) facilitate user log in authentication;
e) compress data prior to communicating with the cloud server; and
f) interface with an integrated global position system of a user device to calibrate a clock controller of the printed circuit board assembly;
wherein the artificial intelligence component is trained on at least one dataset to recognize a fault scenario;
wherein the integrated software and the GUI are further configured to at least one of: (i) receive data, (ii) control a timer, (iii) control a schedule, (iv) view data, (v) transmit data, (vi) control a status of the smart circuit breaker, (vii) latch and unlatch the at least one relay, (viii) perform an update, (ix) control a plurality of smart circuit breakers, or any combination thereof; and
wherein the artificial intelligence component is further configured to at least one of: (i) collect data, (ii) build neural networks from the data collected, (iii) monitor the condition of the smart circuit breaker, (iv) monitor the status of the smart circuit breaker, (v) identify a fault in a branch circuit, (vi) identify a location of the fault identified, (vii) determine a type of fault identified, (viii) communicate with the cloud server, (ix) communicate with a weather service, (x) analyze electrical characteristics of a branch circuit, (xi) communicate with an internet of things connected device, (xii) communicate with integrated software to open or close a circuit, (xiii) communicate with a wireless network, and (xiv) identify at least one appliance connected to a branch circuit, or any combination thereof.

18-27. (canceled)

28. The smart circuit breaker of system claim 1, wherein the smart circuit breaker includes at least one network connection (i) an internet connection, (ii) an intranet connection, (iii) a Bluetooth connection, (iv) a Wi-Fi connection, (v) a wireless access network connection, (vi) a local area network connection, and (vii) a cloud server, or any combination thereof.

29. The smart circuit breaker system of claim 1, wherein the smart circuit breaker is configured to be either a two-pole breaker or a tandem breaker during an instillation of the smart circuit breaker.

30. The smart circuit breaker system of claim 1, wherein the smart circuit breaker is configured to at least one of enable or disable ground fault circuit interrupting (GFCI), and to enable or disable arc fault circuit interrupting (AFCI).

31. The smart circuit breaker system of claim 30, further comprising a fuse, and wherein the fuse is connected AFCI or GFCI is enabled, and wherein the fuse is disconnected AFCI or GFCI is disabled.

32. The smart circuit breaker system of claim 1, wherein the at least one relay comprises:
a mechanical switch configured to mechanically toggle the at least one relay in the open and the closed positions, respectively; and
a spring detent on the mechanical switch, the spring detent configured to disengage the mechanical switch from the at least one relay when the mechanical switch toggles the at least one relay in the closed position.

33. (canceled)

34. (canceled)

35. The smart circuit breaker system of claim 1, wherein the printed circuit board assembly is further configured to monitor current on the at least one mains.

36. The smart circuit breaker system of claim 1, further comprising an integrated battery backup;
wherein the integrated battery backup is any one of a cell battery or a super-capacitor, or other appropriate energy storage device.

37. The smart circuit breaker system of claim 36, wherein the integrated battery backup is any one of a cell battery or a super-capacitor.

38. The smart circuit breaker system of claim 1, further comprising:
at least one sensing coil operatively coupled to the at least one relay and the printed circuit board assembly, and at least one resistive shunt operatively coupled to the at least one relay and to the printed circuit board assembly;
the at least one sensing coil configured to provide a measurement of current flow to the branch circuit to the printed circuit board assembly; and
the at least one resistive shunt configured to provide a measurement of at least one of current and voltage to the branch circuit to the printed circuit board assembly.

39. A method of providing overcurrent protection via a smart circuit breaker, the method comprising:
connecting a line side connection to a power distribution panel bus, a load side connection to at least one branch circuit, and at least one relay coupled to a line side of the at least one branch circuit; and
connecting a printed circuit board assembly, the printed circuit board assembly comprising a processor and a memory with computer code instructions stored thereon configured to cause the processor to perform at least one of: controlling operation of the at least one relay, recording electrical characteristics through the smart circuit breaker, and providing at least one network connection to the smart circuit breaker.

40. The method of providing overcurrent protection via a smart circuit breaker of Claim 39, further comprising measuring current flow in the at least one branch circuit via at least one sensing coil operatively coupled to the at least one relay and transmitting the measurement of current flow to the printed circuit board assembly.

41. The method of providing overcurrent protection via a smart circuit breaker of Claim 39, further comprising measuring current and voltage to the branch circuit via at least one resistive shunt operatively coupled to the at least one relay and transmitting the measurement of current and voltage to the printed circuit board assembly.

42. The method of providing overcurrent protection via a smart circuit breaker of claim 39, further comprising, by the printed circuit board assembly with the processor and the memory with computer code instructions stored thereon:
(i) recording at least a measurement and a waveform of at least one of current and voltage;
(ii) indicating the current status of the smart circuit breaker via at least one light emitting diode (LED);
(iii) enabling communication between at least one additional smart circuit breaker via the at least one network connection;
(iv) identifying a ground fault within the branch circuit, and producing an open circuit in response to the identifying of a ground fault;
(v) identifying an arc fault within the branch circuit, and producing an open circuit in response to the identifying of an arc fault; and
(vi) identifying an over temperature condition in the breaker and producing an open circuit in response to the identifying of an over temperature condition, or any combination thereof.

43. The method of providing overcurrent protection via a smart circuit breaker of claim 42, further comprising responsive to a value of the measured waveform, producing an open circuit.

44. The method of providing overcurrent protection via a smart circuit breaker of Claim 39, wherein the at least one relay is electro-mechanical switch, the method further comprising respectively opening and closing a circuit via the electro-mechanical switch.

45. The method of providing overcurrent protection via a smart circuit breaker of claim 39, further comprising respectively opening and closing the at least one branch circuit, via the at least one relay, responsive to a condition, wherein the condition is any one of: (i) a fault scenario, (ii) a wireless communication, (iii) a wired communication, and (iv) a schedule or timer.

46. (canceled)

47. The method of providing overcurrent protection via a smart circuit breaker of claim 39, further comprising coupling an overcurrent protection mechanism to the smart circuit breaker, wherein the overcurrent protection mechanism is at least one of: (i) thermal based, (ii) magnetically based, (iii) digitally based, and (iv) temperature based, or any combination thereof.

48. (canceled)

49. The method of providing overcurrent protection via a smart circuit breaker of claim 39, wherein the at least one relay is a double latching relay.

50. The method of providing overcurrent protection via a smart circuit breaker of claim 39, further comprises integrating a firmware to the printed circuit board assembly, the integrated firmware and memory having computer code instructions stored thereon configured to:
(i) manage the at least one network connection;
(ii) operatively couple the printed circuit board assembly to the overcurrent protection device;
(iii) interface between an internet of things (IoT) cloud server and the smart circuit breaker;
(iv) interface between the smart circuit breaker and at least one additional smart circuit breaker;
(v) maintain a secure socket layer communication, manage over the air updates, sense errors in the system;
(vi) managing firmware patches; and
(vii) update at least one parameter configured to cause the at least one relay to produce an open circuit.

51. (canceled)

52. (canceled)

53. The method of providing overcurrent protection via a smart circuit breaker of claim 39, further comprising, recording and storing, via the processor and the memory and the computer code instructions stored thereon, data associated with at least one branch circuit, wherein data is at least one of: (i) power usage monitored by the circuit breaker, (ii) a current waveform (i) a voltage waveform, (iv) an indication of active circuits, (v) energy usage history, (vi) predictions on future energy needs or habits, (vii) a timer, (viii) a schedule, (ix) an indication of smart circuit breaker status, (x) a fault detection, (xi) fault detection history, (xii) an indication of temperature, and (xiii) power outages, or any combination thereof.

54. (canceled)

55. The method of providing overcurrent protection via a smart circuit breaker of claim 39, further comprising integrating software with the memory, the integrated software having an artificial intelligence component having a lossless audio codec configured to compress data prior to communicating with a cloud server, the integrated software further configured to:
a) provide a graphic user interface (GUI) on an IoT connected user device;
b) represent data via the GUI to the IoT connected user device;
c) communicate with the cloud server;
d) facilitate user log in authentication;
e) compress data prior to communicating with the cloud server; and
f) interface with an integrated global position system of a user device to calibrate a clock controller of the printed circuit board assembly;
wherein the artificial intelligence component is trained on at least one dataset to recognize a fault scenario;
wherein the integrated software and the GUI are further configured to at least one of: (i) receive data, (ii) control a timer, (iii) control a schedule, (iv) view data, (v) transmit data, (vi) control a status of the smart circuit breaker, (vii) latch and unlatch the at least one relay, (viii) perform an update, (ix) control a plurality of smart circuit breakers, or any combination thereof; and
wherein the artificial intelligence component is further configured to at least one of: (i) collect data, (ii) build neural networks from the data collected, (iii) monitor the condition of the smart circuit breaker, (iv) monitor the status of the smart circuit breaker, (v) identify a fault in a branch circuit, (vi) identify a location of the fault identified, (vii) determine a type of fault identified, (viii) communicate with the cloud server, (ix) communicate with a weather service, (x) analyze electrical characteristics of a branch circuit, (xi) communicate with an internet of things connected device, (xii) communicate with integrated software to open or close a circuit, (xiii) communicate with a wireless network, and (xiv) identify at least one appliance connected to a branch circuit, or any combination thereof.

56-65. (canceled)

66. The method of providing overcurrent protection via a smart circuit breaker of claim 39, wherein the at least one network connection is any one of: (i) an internet connection, (ii) an intranet connection, (iii) a Bluetooth connection, (iv) a Wi-Fi connection, (v) a wireless access network connection, (vi) a local area network connection, (vii) a cloud server, and (viii) a cellular network, or any combination thereof.

67. The method of providing overcurrent protection via a smart circuit breaker of claim 39, wherein the smart circuit breaker is configured to be either a two-pole breaker or a tandem breaker during an installation of the smart circuit breaker.

68. The method of providing overcurrent protection via a smart circuit breaker of claim 39, further comprising:
enabling or disabling ground fault circuit interrupting (GFCI), and enabling or disabling arc fault circuit interrupting (AFCI);
configuring at least one fuse to enable the ground fault circuit interrupting (GFCI) or the arc fault circuit interrupting (AFCI);
configuring the at least one fuse to disable the ground fault circuit interrupting (GFCI) or the arc fault circuit interrupting (AFCI); and
configuring the fuse configured to be disconnected if ground fault circuit interrupting (GFCI) or the arc fault circuit interrupting (AFCI) is disabled.

69. (canceled)

70. The method of providing overcurrent protection via a smart circuit breaker of claim 39, further comprising:
manually toggling the at least one relay in the open and closed positions, respectively, via a mechanical switch; and
disengaging the mechanical switch from the at least one relay via a spring detent when the mechanical switch toggles the at least one relay in the closed position a mechanical switch configured to mechanically toggle the at least one relay in the open and the closed positions, respectively.

71. (canceled)

72. The method of providing overcurrent protection via a smart circuit breaker of claim 39, further comprising providing a measurement of temperature to the printed circuit board assembly by a temperature sensor.

73. The method of providing overcurrent protection via a smart circuit breaker of claim 39, further comprising monitoring current on at least one mains.

74. The method of providing overcurrent protection via a smart circuit breaker of claim 39, further comprising integrating a battery backup, wherein the integrated battery backup is any one of a cell battery or a super-capacitor.

75. (canceled)

76. The method of providing overcurrent protection via a smart circuit breaker of claim 39, further comprising:
coupling at least one sensing coil to the at least one relay and the printed circuit board assembly, and coupling at least one resistive shunt to the at least one relay and to the printed circuit board assembly;
configuring the at least one sensing coil to provide a measurement of current flow to the branch circuit to the printed circuit board assembly; and
configuring the at least one resistive shunt to provide a measurement of at least one of current and voltage to the branch circuit to the printed circuit board assembly.

77. The method of providing overcurrent protection via a smart circuit breaker of claim 39 further configuring the smart circuit breaker to provide the overcurrent protection by:
configuring the smart circuit breaker to be a main overcurrent protection device for an electrical distribution panel;
identifying, via the smart circuit breaker, a plurality of electrical loads on a load side of the smart circuit breaker within the electrical distribution panel; and
balancing the plurality electrical loads between a plurality of electrical phases within the electrical distribution panel.

78. The method of controlling electrical load distribution of claim 77, wherein balancing the plurality of electrical loads further comprises integrating an artificial intelligence component configured to perform at least one of: controlling power distribution to each electrical phase of the plurality of electrical phases, and
communicating a load balancing suggestion to a user;
configuring the artificial intelligence component to perform at least one of: (i) learning the load balancing properties of the electrical distribution panel, (ii) instructing the smart circuit breaker on how to balance the loads, and (iii) communicating a load balancing suggestion to a user.

79-82. (canceled)
